(19) United States
(12) Patent Application Publication
(10) Pub. No.: US 2018/0203851 A1
(43) Pub. Date: Jul. 19, 2018

(54) SYSTEMS AND METHODS FOR AUTOMATED HAIKU CHATTING

(71) Applicant: Microsoft Technology Licensing, LLC, Redmond, WA (US)

(72) Inventor: Xianchao Wu, Tokyo (JP)

(73) Assignee: Microsoft Technology Licensing, LLC, Redmond, WA (US)

(21) Appl. No.: 15/405,532

(22) Filed: Jan. 13, 2017

(51) Int. Cl. G06F 17/28; G06F 17/27; G06T 9/00; G06F 17/30; G06N 3/08

(52) U.S. Cl. CPC G06F 17/2881; G06F 17/2785; G06T 9/002; G06N 3/08; G06F 17/30253; G06F 17/3028; G06F 17/30675

(57) ABSTRACT

Systems and methods for automated (or artificial intelligence) haiku chatting are provided. The systems and methods provide automated haiku chatting by generating, selecting, and/or scoring haikus. The systems and methods provide automated haiku chatting that may generate and/or select a haiku based on previously collected user inputs, that provides an image with a selected and/or generated haiku, that may generate or select a haiku based on an collected image from the user, and/or that may utilize bi-directional recurrent neural network learning model. Further, systems and methods as described herein are able update or train learning models utilized by the systems and/or methods based on user feedback and/or world feedback.

### BACKGROUND

Bots are becoming more and more prevalent and are being utilized for more and more different tasks. As understood by those skilled in the art, bots are software applications that may run automated tasks over a network, such as the Internet. Chat bots are designed to conduct a conversation with a user via text, auditory, and/or visual methods to simulate human conversation. A chat bot may utilize sophisticated natural language processing systems or scan for keywords from a user input and then pull a reply with the most matching keywords or the most similar wording pattern from a database. However, chat bots are often limited to simple task driven conversations.

It is with respect to these and other general considerations that aspects disclosed herein have been made. Also, although relatively specific problems may be discussed, it should be understood that the aspects should not be limited to solving the specific problems identified in the background or elsewhere in this disclosure.

### SUMMARY

In summary, the disclosure generally relates to systems and methods for haiku automated chatting that generate, select and/or score a haiku for a user. The systems and methods provide automated haiku chatting that may generate and/or select a haiku based on previously collected user inputs, that provides an image with a selected and/or generated haiku, that may generate or select a haiku based on a collected image from the user, and/or that may utilize a bi-directional recurrent neural network learning model. Further, the systems and methods as described herein are able update or train learning models utilized by the systems or methods based on user feedback and/or world feedback. As such, the systems and methods as described herein perform automated haiku chatting that is more effective, more engaging, and easier to use than previously utilized chat bots that were not able to select or generate haikus from user inputs, select or generate haikus from user provided images, select or generate haiku with related images, and/or select or generate haiku utilizing bi-directional deep learning analysis.

One aspect of the disclosure is directed to a system for a haiku chat bot. The system includes at least one processor and a memory. The memory encodes computer executable instruction that, when executed by the at least one processor, are operative to:
collect user inputs;
generate user haikus based on the user inputs;
store the user haikus in a user haiku database;
collect a haiku query from a user;
evaluate the haiku query to determine a key feature;
determine that the key feature meets an input threshold;
compare at least one of the haiku query and the key feature to the user haikus in the user haiku database to determine a semantic similarity;
collect a result haiku from the user haikus in the user haiku database based on the semantic similarity; and
provide the result haiku to the user in reply to the haiku query.

In another aspect, a method for automated haiku chatting is disclosed. The method includes:
collecting a haiku generation query from a user, wherein the haiku generation query includes an image;
evaluating the image to determine an image feature;
evaluating the image feature to generate a new haiku, wherein words for the new haiku are extracted from at least one of user haikus in a user haiku database or from known haikus in a world haiku database and combined to form the new haiku; and providing the new haiku to the user in reply to the haiku generation query.

In yet another aspect of the invention, the disclosure is directed to a system for a haiku chat bot. The system includes at least one processor and a memory. The memory encodes computer executable instruction that, when executed by the at least one processor, are operative to:
collect a haiku generation query from a user;
evaluate the haiku generation query to generate a new haiku, wherein words for the new haiku are extracted from user haikus in a user haiku database and combined to form the new haiku; and
provide the new haiku to the user in reply to the haiku generation query.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive embodiments are described with reference to the following Figures.

FIG. 1A is a schematic diagram illustrating a haiku chat bot on a client computing device being utilized by a user, in accordance with aspects of the disclosure.

FIG. 1B is a schematic diagram illustrating a haiku chat bot on a server computing device being utilized by a user via a client computing device, in accordance with aspects of the disclosure.

FIG. 2A is a schematic diagram illustrating a screen shot of a user interface of a user's client computing device during a conversation with a haiku chat bot, in accordance with aspects of the disclosure.

FIG. 2B is a schematic diagram illustrating a screen shot of the user interface of the user's client computing device shown in FIG. 2A during a new conversation with the haiku chat bot, in accordance with aspects of the disclosure.

FIG. 2C is a schematic diagram illustrating a screen shot of the user interface of the user's client computing device shown in FIG. 2A during a new conversation with the haiku chat bot, in accordance with aspects of the disclosure.

FIG. 2D is a schematic diagram illustrating a screen shot of the user interface of the user's client computing device shown in FIG. 2A during a new conversation with the haiku chat bot, in accordance with aspects of the disclosure.

FIG. 2E is a schematic diagram illustrating a screen shot of the user interface of the user's client computing device shown in FIG. 2A during a new conversation with the haiku chat bot, in accordance with aspects of the disclosure.

FIG. 3A is a schematic diagram illustrating an example of a recurrent neural network with gated recurrent units to learn the similarity among a haiku query and chat bot haiku response, in accordance with aspects of the disclosure.

FIG. 3B is a schematic diagram illustrating an example of a left-to-right expedition of the haiku query sequence by the GRU formula of FIG. 3A for the forward process, in accordance with aspects of the disclosure.

FIG. 3C is a schematic diagram illustrating an example of a right-to-left expedition of the haiku query sequence by using GRU formula shown in FIG. 3A for the backward process, in accordance with aspects of the disclosure.

FIG. 4 is a block flow diagram illustrating a method for automated haiku chatting, in accordance with aspects of the disclosure.

FIG. 5 is a block diagram illustrating example physical components of a computing device with which various aspects of the disclosure may be practiced.

FIG. 6A is a simplified block diagram of a mobile computing device with which various aspects of the disclosure may be practiced.

FIG. 6B is a simplified block diagram of the mobile computing device shown in FIG. 6A with which various aspects of the disclosure may be practiced.

FIG. 7 is a simplified block diagram of a distributed computing system in which various aspects of the disclosure may be practiced.

FIG. 8 illustrates a tablet computing device with which various aspects of the disclosure may be practiced.

FIG. 9 is a schematic diagram illustrating a work flow of the creation and storage of user haikus from user inputs, in accordance with aspects of the disclosure.

FIG. 10 a schematic diagram illustrating a recurrent neural network and related equation for each layer of the recurrent neural network, in accordance with aspects of the disclosure.

FIG. 11 a schematic diagram illustrating a framework of an image-haiku similarity model, in accordance with aspects of the disclosure.

FIG. 12 is a schematic diagram illustrating a framework for a haiku-image generation model, in accordance with aspects of the disclosure.

FIG. 13 block flow diagram illustrating a method for training a similarity model utilizing user feedback, in accordance with aspects of the disclosure.

FIG. 14 block flow diagram illustrating a method for training a haiku-image similarity model utilizing user and world feedback, in accordance with aspects of the disclosure.

FIG. 15 is a schematic diagram illustrating a work flow for a haiku scoring system, in accordance with aspects of the disclosure.

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the spirit or scope of the present disclosure. The following detailed description is therefore not to be taken in a limiting sense, and the scope of the present disclosure is defined by the claims and their equivalents.

Bots are becoming more and more prevalent and are being utilized for more and more different tasks. As understood by those skilled in the art, bots are software applications that may run automated tasks over a network, such as the Internet. Chat bots are designed to conduct a conversation with a user via auditory or visual methods to simulate human conversation. A chat bot may utilize sophisticated natural language processing systems or scan for keywords from a user input and then pull a reply with the most matching keywords or the most similar wording pattern from a database. Artificial intelligent chat bots are being utilized by more and more young people today. However, other older traditions are losing favor amongst younger generations, such as “haikus” a form a traditional Japanese poetry. The Japanese haiku expresses emotion, season, and reasoning in a compact way. However, haikus are rarely utilized in everyday life and are difficult to create because of a strict three line structure that requires rhyming.

As such, the systems and method as disclosed herein are directed to an artificial intelligence (AI) haiku chat bot that can select, generate, and/or score haikus for a user. The AI haiku chat bot may utilize collected user inputs to generate or select haikus that are based on the user's own language. Further, the AI haiku chat bot may generate a haiku from a user provided image. Additionally, the AI haiku chat bot may provide an image with a selected or generated haiku. Further, the AI haiku chat bot utilizing deep learning that analyzes the user input from left-to-right and from right-to-left to generated and/or select the haiku. In contrast, previously utilized AI chat bots were not able to provide images with haiku results, generate new haikus from a collected image, generated haikus from the user's own inputs, and/or did not utilized deep learning analysis in both directions to generate or select a haiku.

The ability of the systems and methods to perform automated haiku chatting as described herein provides a chat bot that is capable of providing user created haikus based on various different inputs from the user. Further, the ability of the systems and methods described herein to utilize deep learning in both directions improves the generation and/or selection of a haiku by the chat bot. As such, the systems and methods that perform automated haiku chatting as described herein provide a chat bot that is more effective, more engaging, and easier to use than previously utilized haiku chat bots that were not able to provide images with haiku results, generate new haikus from a collected image, generate haikus from the users own inputs, and/or utilize deep learning analysis in both directions.

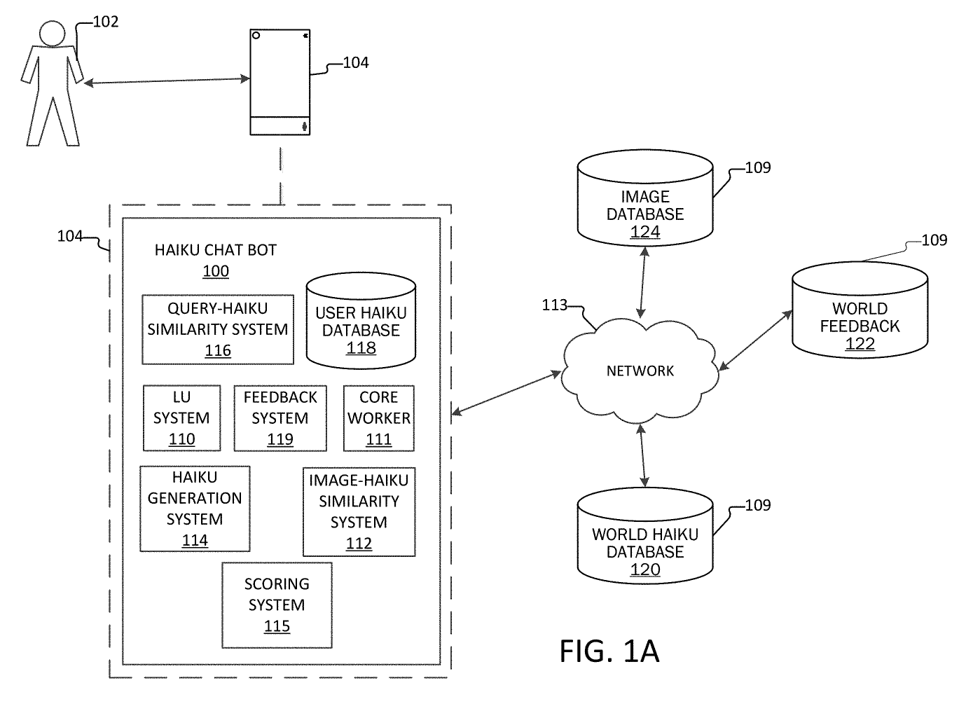

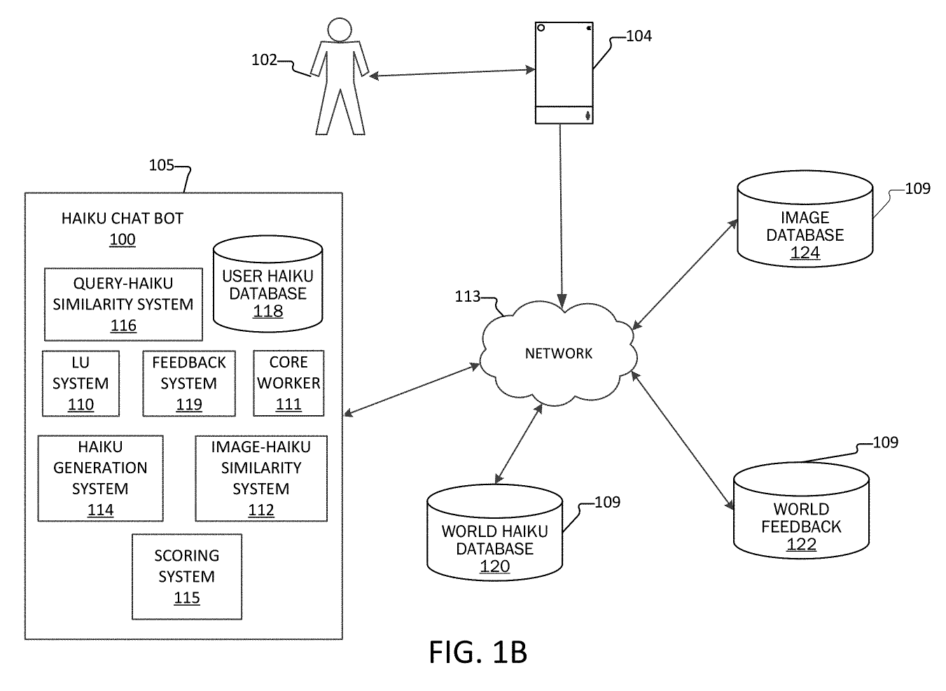

FIGS. 1A and 1B illustrate different examples of a haiku chat bot 100 or an AI haiku chat bot 100 being utilized by a user, in accordance with aspects of the disclosure. In some aspects, the haiku chat bot 100 is part of a larger application, such as a digital assistant application. In other aspects, the haiku chat bot 100 is a standalone application utilized by a client computing device 104 or server computing device 105. A user 102 as utilized herein refers to an individual user of the chat bot 100 or to a group users of the chat bot 100 that may be identified with a single identification, such as company A users, friend group B user, etc.

The chat bot 100 is capable of generating, selecting, and/or scoring a haiku from various different user inputs, such as images. Further, the chat bot 100 may utilize bi-directional deep learning analysis of a user haiku query to generate, select, and/or score a haiku from various different user inputs, such as images. In some aspects, the chat bot 100 is capable of generating and/or selecting a haiku that is created entirely from inputs previously received from the user. Further, the chat bot 100 is capable of providing an image along with haiku that relates to the selected and/or generated haiku. As such, the haiku chat bot 100 is more effective, more engaging, and easier to use than previously utilized haiku chat bots that were not able to provide images with haiku results, generate new haikus from a collected image, generate haikus from the users own inputs, and/or utilize deep learning analysis in both directions.

The chat bot 100 includes a language understanding (LU) system 110, a core worker 111, an image-haiku similarity system 112, a haiku generation system 114, a scoring system 115, a query-haiku similarity system 116, a user haiku database 118, and/or a feedback system 119. In alternative aspects, the user haiku database 118 is not part of the chat bot 100 and is instead separate and distinct from the chat bot 100. In these embodiments, the chat bot 100 communicates with the user haiku database 118 via a network 113. In some aspects, the network 113 is a distributed computing network, such as the internet. The chat bot 100 may also communicate with other databases 109 and/or servers 105, such as database that tracks and stores world feedback 122, an image database 124, and/or a world haiku database 120.

In some aspects, the chat bot 100 is implemented on the client computing device 104 as illustrated by FIG. 1A. In a basic configuration, the client computing device 104 is a computer having both input elements and output elements. The client computing device 104 may be any suitable computing device for implementing the chat bot 100. For example, the client computing device 104 may be a mobile telephone, a smart phone, a tablet, a phablet, a smart watch, a wearable computer, a personal computer, a gaming system, a desktop computer, a laptop computer, and/or etc. This list is exemplary only and should not be considered as limiting. Any suitable client computing device 104 for implementing the chat bot 100 and/or for communicating with the chat bot 100 may be utilized.

In other aspects, the chat bot 100 is implemented on a server computing device 105, as illustrated in FIG. 1B. The server computing device 105 may provide data to and/or receive data from the client computing device 104 through the network 113. In further aspects, that chat bot 100 is implemented on more than one server computing device 105, such as a plurality or network of server computing devices 105. For example, the user haiku database 118 may be located on a server or a database separate from a server containing the core worker 111. In some aspects, the chat bot 100 is a hybrid system with portions of the chat bot 100 on the client computing device 104 and with portions of the chat bot 100 on one or more server computing devices 105.

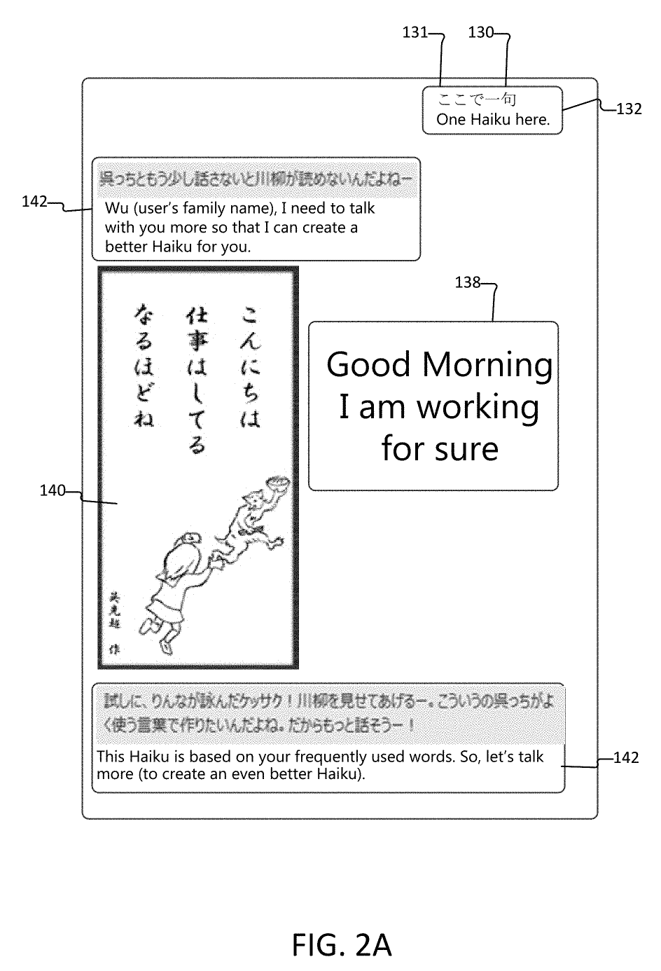

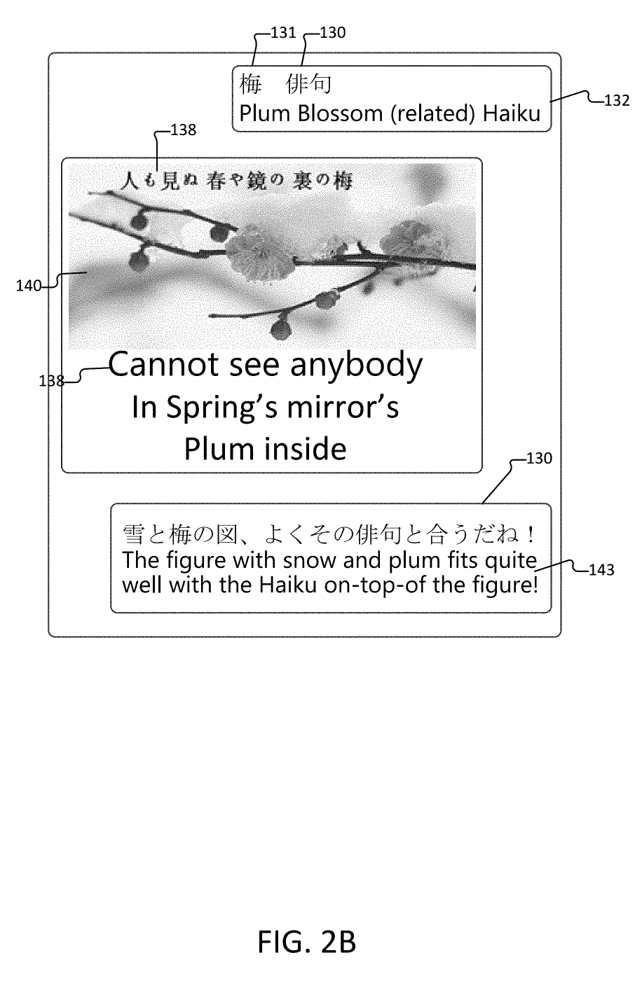

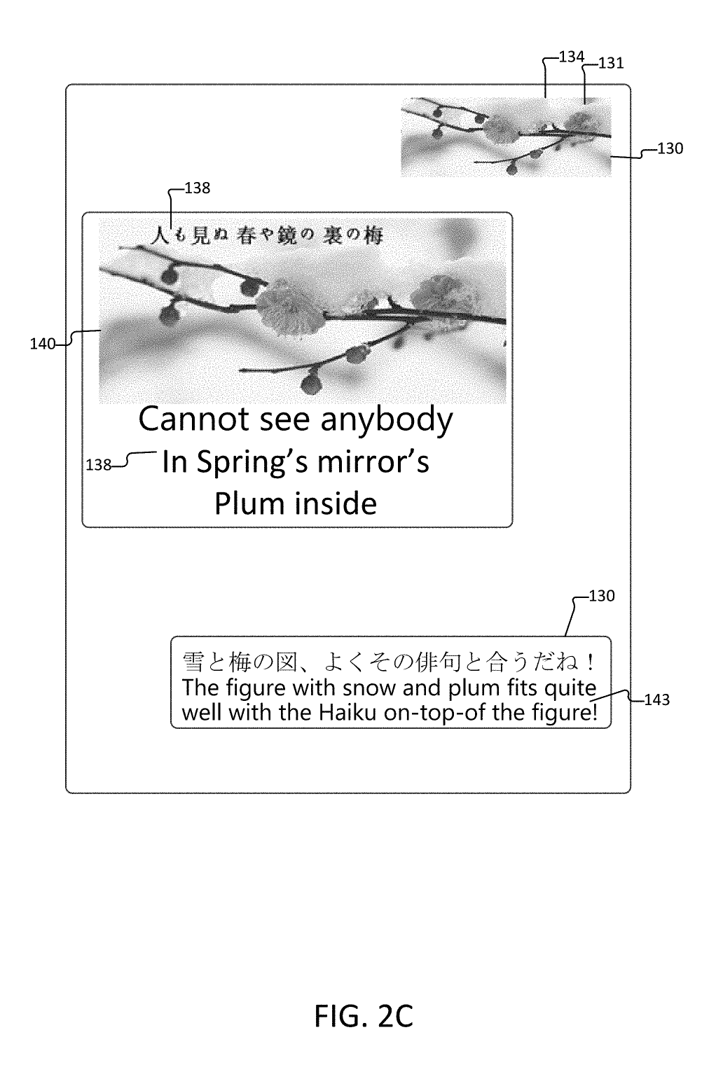

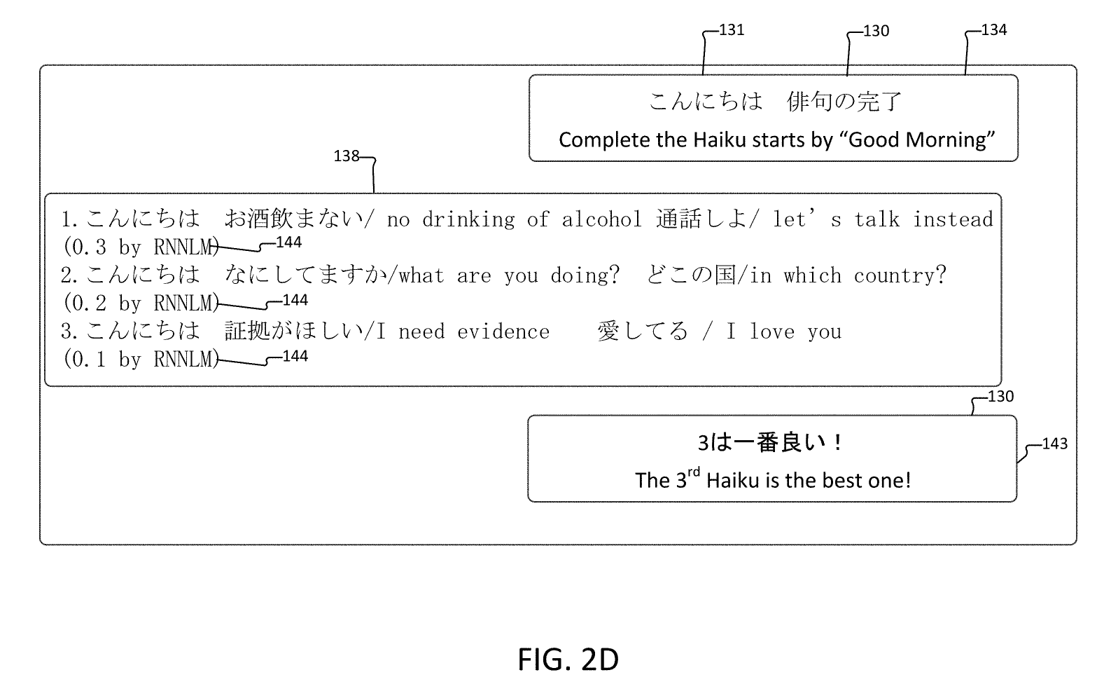

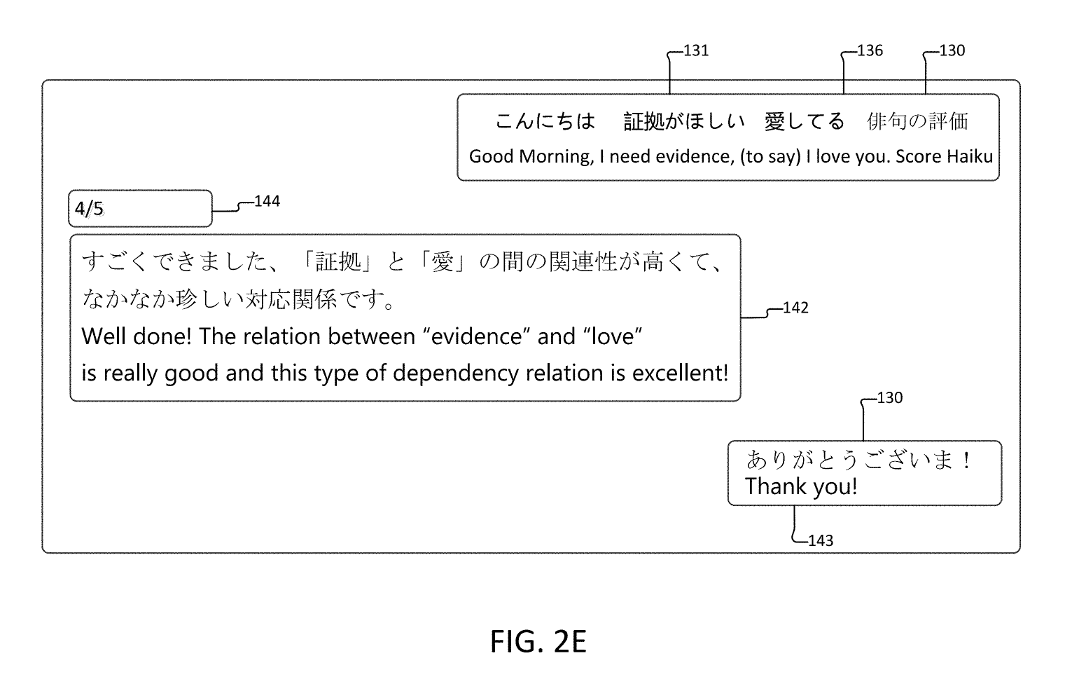

FIGS. 2A-2E illustrate screen shots of a user interface 200 of a client computing device 104 of a user 102 during different conversations with a haiku chat bot 100, in accordance with aspects of the disclosure. FIG. 2A illustrates that the a chat bot 100 is capable of providing a haiku created entirely from previously received user inputs and providing a related image to the user haiku in response to a haiku query. FIG. 2B illustrates that the chat bot 100 is capable of selecting a known haiku and providing a related image based on collected user input containing only a couple of words. FIG. 2C illustrates that the chat bot 100 is capable of generating a new haiku with a related image from a user input of an image. FIG. 2D illustrates that the chat bot 100 is capable of generating a new haiku with words selected from prior user inputs and providing a related image to the generated haiku based on a user input containing only a couple of words. FIG. 2D further illustrates, the haiku chat bot 100 is capable of scoring a haiku generated by the chat bot 100. FIG. 2E illustrates that the chat bot 100 is capable of scoring a haiku collected from a user. Further, FIGS. 2A-2E show that the user may provide feedback to the haiku chat bot 100 in reply to receiving a haiku chat bot generated answer.

In some aspects, the haiku chat bot generated answer is provided by the client computing device 104 to the user 102. In other aspects, the chat bot 100 sends instructions to the client computing device 104 to provide the haiku chat bot generated answer to the user 102. The client computing device 104 provides the haiku chat bot generated answer utilizing any known visual, audio, tactile, and/or other sensory mechanisms. For example, the user interface of the client computing device 104 may display the haiku chat bot generated answer as text.

The haiku chat bot 100 collects user inputs 130. In some aspects, the haiku chat bot 100 collects user inputs provided to the application running the haiku chat bot 100. In other aspects, the haiku chat bot 100 collects any user inputs 130 that the haiku chat bot 100 can access whether provided to the application running the haiku chat bot 100 or to another application in communication with the haiku chat bot 100.

The user 102 provides input 130 into a user interface. The input 130 as utilized herein refers to a user question, a user comment, or any other user input information that may be collected by the chat bot 100. The user input 130 as utilized herein includes haiku queries 131. Haiku queries 131 as utilized herein refer to a user request for a haiku 132, a request to complete a haiku 134, and/or a request to score a haiku 136. The user 102 may provide his or her input 130, such as a haiku query 131, as text, video, audio, and/or any other known method for providing input. In the user's input area, a user 102 can type text, select emoji symbols, and insert an image. Additionally, the user 102 can make a voice call or a video conversation with the chat bot 100. For example, the user interface of the client computing device 104 may receive the user's haiku query 131 as voice input.

The chat bot 100 collects the user input 130 from the client computing device 104. The term “collect” as utilized herein refers to the passive receiving or receipt of data and/or to the active gathering or retrieval of data. The core worker 111 of the chat bot 100 collects the user input 130.

For example, in the user interface (UI) as shown in FIG. 2A, the chat bot 100 collects the user input 130 of a haiku request 132 of “One haiku please”. The above sentence is transferred to the “request queue”, which stores users' requests in multimedia format including texts, sounds, images, and even videos by the core worker 111 of the chat bot 100. However, the chat bot 100 deals with different kinds of multimedia inputs differently. For example, for real-time sounds and videos, the AI chat both 100 needs a sufficient amount of core workers 111 to ensure that the queue is not too long so a user utilizing the chat bot 100 does not receive too long of a delay between his or her input 130 and the AI chat bot 100 reply. For texts and images, the chat bot 100 may utilize less core workers 111 for processing.

The core worker 111 collects the request queue as input. Requests in the queue are served and/or responded to in first-in-first-out manner by the core worker 111. As such, the core worker 111 will one-by-one determine a type of input (voice, video, text, etc.) of each query 130 for proper processing by the chat bot 100. For example, the core worker 111 will send the user inputs 130 and/or LU processes user inputs to the image-haiku similarity system 112, the haiku generation system 114, the scoring system 115, the query-haiku similarity system 116, and/or feedback system 119.

The core worker 111 utilizes or sends the user's input 130 to a LU system 110 for processing. The LU system 110 converts the user's queries 130 into text and/or annotated text. The LU system 110 includes application programming interfaces (APIs) for text understanding, speech recognition, and/or image/video recognition for processing user queries 130 into text and/or annotated text form.

Sounds need to be recognized and decoded as texts. A speech recognition API may be necessary for the speech-to-text conversion task and is part of the LU system 110. Furthermore, the LU system 110 may need to convert a generated response from text to voice to provide a voice response to the user 102. Further, the LU system 110 may also include an image recognition API to “read” and “understand” received images from the user 102. In some aspects, the image recognition API of the LU system 110 translates or decodes received images into text. Further, a feedback response by the chat bot 100 may be translated into images by the LU system 110 to provide an image response to the user 102. For example, if the selected response is good job, the LU system 110 could convert this text into a thumbs-up, which is displayed to the user as an image or emoticon. The core worker framework allows APIs to be easily added or removed. As such, the core worker framework is extensible.

The generated or selected haikus or the haiku score determined by the chat bot 100 are provided to the core worker 111. The core worker 111 transfers the response to the response queue or into a cache. The cache is necessary to make sure that a sequence of chat bot responses 142 or replies 142 can be shown to the user in a pre-defined time stream. That is, for one user's request, if there are no less than two responses generated by the core worker 111, then a time-delay setting for the responses may be necessary.

For example, as illustrated in FIG. 2A, in response to a user haiku query 136, the chat bot 100 may generate two responses, such as “please talk with me more so that I can provide you with a better haiku,” 142 and a selected haiku 138. In this scenario the core worker 111 ensures that the first response is provided to the user immediately. Also, the core worker 111 of the chat bot 100 may ensure that the second haiku response is provided in a time delay, such as 1 or 2 seconds, so that the second message will be provided to the user two seconds after the first message. As such, the cache of the core worker 111 manages these to-be-sent response messages together with user identities and appropriate timing for each chat bot generated question or comment.

The core worker 111 based on information from the LU system 110 determines if the user input 130 is a haiku query 131 and if so, what kind of haiku query 131, such as a user request for a haiku 132, a request to complete a haiku 134, and/or a request to score a haiku 136. The text or annotated text, haiku query determination, and/or collected inputs generated by the LU system 110 and/or core worker 111 is collected by the haiku generation system 114, scoring system 115, query-haiku similarity system 116, and/or the feedback system 119.

The query-haiku similarity system 116 selects an already formed haiku from a user haiku database 118 and/or a world haiku database 120 in response to collecting a user request for a haiku 132 from the core worker 111. Next, the query-haiku similarity system 116 provides the selected haiku to the user 102 in reply to the user's haiku request 132. The user request for the haiku 132 may include a keyword for the haiku. The query-haiku similarity system 116 may be able to extract the keyword from the user's haiku request 132. In these aspects, the selected haiku by the query-haiku similarity system 116 will relate to the keyword. For example, FIG. 2B illustrates a haiku request 132 of “a plum blossom haiku” and in response the haiku chat bot 100 replies with a haiku 138 and image 140 relating to a plum blossom.

The world haiku database 120 is one or more databases 109 that store publically available haikus that may be accessed by the chat bot 100 via a network. The user haiku database 118 is created by the haiku generation system 114 of the chat bot 100. The user haiku database 118 includes haikus that have been created by the haiku generation system 114 from inputs received from the user 102 by the chat bot 100.

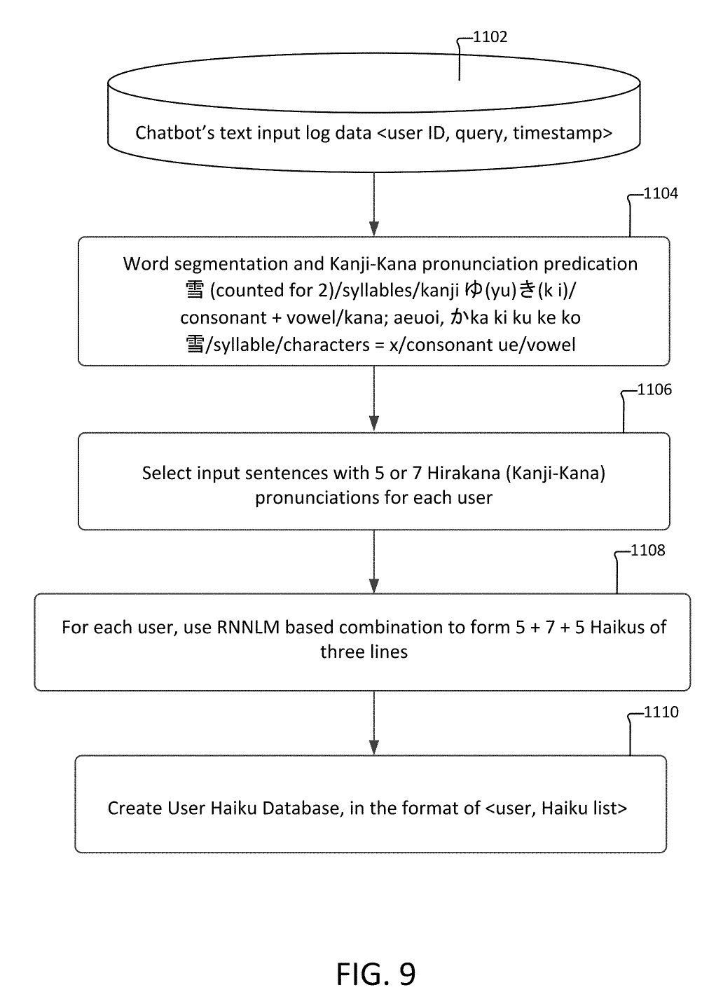

FIG. 9 is an example of a schematic diagram of a work flow utilized by the haiku generation system 114 in the creation and storage of user haikus from user inputs, in accordance with aspects of the disclosure. As illustrated in FIG. 9, the haiku generation system 114 collects the user inputs 130 at operation 902. Next, the haiku generation system 114 analyzes each sentence in the user input to determine the Kanji-Kana pronunciation of each sentence. In some languages where no spaces are provided between words, such as with Japanese, word segmentation is performed to provide a list of words in the user sentence input.

A haiku requires three lines with the first line having 5 Kanji-Kana, the second line having 7 Kanji-Kana, and the last line having 5 Kanji-Kana. Further, the last word of each line is supposed to rhyme in the haiku. Further, the haiku is supposed to provide juxtaposition between related elements. While the haikus listed in the application do not appear to meet the haiku parameters, that is because the haikus listed in the application are based on or translated from Japanese haikus that meet the haiku parameters when written in Japanese. Accordingly, where appropriate, the Japanese translation for some of the user inputs and chat bot responses has been provided. These haikus in Japanese rhyme and/or meet the haiku line structure limitations.

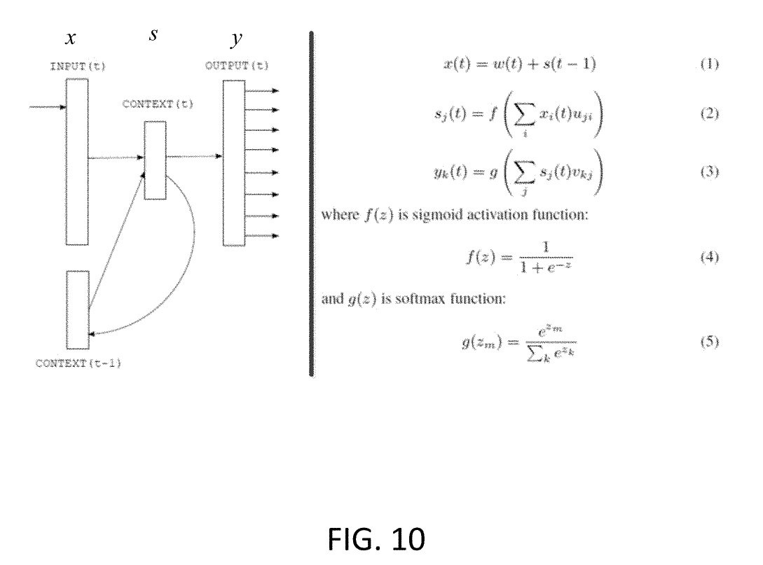

Accordingly, the haiku generation system 114 assigns a Kanji-Kana pronunciation to each collected user input sentence at operation 904. Next, the haiku generation system 114 collects user sentences with assigned Kanji-Kana pronunciations of 5 and 7 at operation 906 since each sentence is a potential single line candidate for a haiku. The haiku generation system 114 utilizes a learning model to select and combine three different sentences with assigned Kanji-Kana pronunciations of 5, 7, and 5 in that order. In some aspects, the haiku generation system 114 utilizes a recurrent neutral network language model (RNNLM) to combine the different user sentences to create a haiku. In further aspects, the haiku generation system 114 utilizes a bi-directional RNNLM to combine the different user sentences to create a haiku. For example, FIG. 10 is a schematic diagram of a RNN and related equations for each layer of the recurrent neural network, in accordance with aspects of the disclosure. As illustrated in FIG. 10, the RNN has an input layer “x,” hidden layer “s” (also called context layer or state) and an output layer “y”. Input to the RNN in time “t” is x(t), output is denoted as y(t), and s(t) is state of the RNN (hidden layer). Input vector x(t) is formed by concatenating vector “w” representing a current word, and output from neurons in context layer “s” at time “t−1”. Input, hidden, and output layers are then computed by the equations of (1) to (5) as shown in FIG. 10. In some aspects, the haiku generation system 114 may utilizing the following combination algorithm for the RNNLM:
For each user input sentence with 5 assigned Kanji-Kana pronunciations, take this input (annotated as q1) as the first line of the target Haiku;
For each input (annotated as q2) with 7 Kanji-Kana pronunciations, compute the probability of <q1, q2> under RNNLM, and select the q2 with the highest probability (annotated as q2.max);
Then for each input (annotated as q3) with 5 Kanji-Kana pronunciations, then use RNNLM again to compute the probability of <q1, q2.max, q3> and select the q3 with the highest probability (annotated as q3.max).
Append <q1, q2.max, q3.max> to the final Haiku database of current user. The format is alike <user.ID, q1+\t′+q2.max+\t′+q3.max>.
   Accordingly, each haiku generated at operation 908 will based entirely on inputs collected from the user. At operation 910, the generated user haikus from the collected user inputs are collected and stored in a user haiku database 118 that is associated with the user 102.

In some aspects, the query-haiku similarity system 116 always selects an already formed haiku from a user haiku database 118 in response to collecting a user request for a haiku 132 from the core worker 111. In other aspects, the query-haiku similarity system 116 always selects an already formed haiku from the world haiku database 120 in response to collecting a user's haiku request 132 from the core worker 111. In other aspects, the query-haiku similarity system 116 compares one or more key features extracted from the user request for a haiku 132 to an input threshold. The input threshold indicates if enough user inputs have been collected for a given key feature or topic to generate a user input haiku. In these aspects, if the one or more key features extracted from the user's haiku request 132 meet an input threshold, the haiku is selected from the user haiku database 118. In these aspects, if the one or more key features extracted from the user's haiku request 132 do not meet an input threshold, the haiku is selected from the world haiku database 120. For example, the chat bot 100 indicates that additional input would be helpful to generate user haikus by reciting, “This Hiaku is based on your frequently used words. So let's talk more (to create an even better Haiku),” as illustrated in FIG. 2A.

The query-haiku similarity system 116 utilizes a query-haiku similarity model to select an already formed haiku from a database. In some aspects, the query-haiku similarity system 116 always searches the user haiku database 118 in response to collecting a user request for a haiku 132 from the core worker 111 and only searches the world haiku database 120 if the query-haiku similarity model is unable to match the user's haiku request 132 to a user haiku in the user haiku database 118. The query-haiku similarity model may utilize a pair-wise learning-to-rank (LTR) framework with gradient boosting decision tree (GBDT) algorithm to rank haiku candidates from one or more databases for a given user's haiku request 132.

In some aspects, the query-haiku similarity model utilizes a deep semantic similarity model and a recurrent neural network with gated recurrent units to select the one or haikus from a database. For example, the deep semantic similarity model may include a language model for information retrieval. Given a user haiku query q and a chat bot response (or, candidate haiku) Q, the feature measures the relevance between q and Q through:

$$P ( q \vert Q ) = {Π}_{w ∈ q} [ ( 1 - λ ) {P}_{ml} ( w \vert Q ) + λ {P}_{ml} ( w \vert C ) ] , \qquad EQ \#1$$

where Pₘₗ(w|Q) represents the maximum likelihood of term w estimated from Q, and Pₘₗ(w|C) is a smoothing item that is calculated as the maximum likelihood estimation in a large-scale corpus C (e.g., the large-scale user haiku database 118 and/or the world haiku database 120). The smoothing item avoids zero probability, which stems from the terms appearing in the candidate haiku but not in the query. λϵ(0, 1) is a parameter that acts as a trade-off between the likelihood and the smoothing item. This feature performs well when there is a great deal of overlap between a user query and a candidate haiku, but when the two present similar meanings with different words, this feature fails to capture their similarity.

The query-haiku similarity model also includes translation-based language models. These models learn term-term and phrase-phrase translation probability from query-good haikus and incorporating the information into maximum likelihood. Given a user query q and a candidate haiku Q, translation-based language is defined as:

$$\begin{matrix}{P}_{trb} ( q \vert Q ) = {Π}_{w ∈ q} [ ( 1 - λ ) {P}_{mx} ( w \vert Q ) + λ {P}_{ml} ( w \vert C ) ] , \\ Where & EQ \#2 \\ {P}_{mx} ( w \vert Q ) = α {P}_{ml} ( w \vert Q ) + β {P}_{tr} ( w \vert Q ) & EQ \#3 \\ {P}_{tr} ( w \vert Q ) = {\sum }_{v ∈ Q} {P}_{tp} ( w \vert v ) {P}_{ml} ( v \vert Q ) . & EQ \#4\end{matrix}$$

Here λ, α, and β are parameters satisfying α+β=1. Pₜₚ(w|v) represents the translation probability from term v in Q to term w in q. The query-haiku similarity model edits distance of character/word level unigrams between user haiku requests 132 and candidate haikus. Further, the query-haiku similarity model determines the maximum subsequence ratio between a user's haiku request 132 and the candidate haiku. Additionally, the query-haiku similarity model determines emotion label similarity between a haiku request 132 and a candidate haiku in the user haiku database 118 or the world haiku database 120.

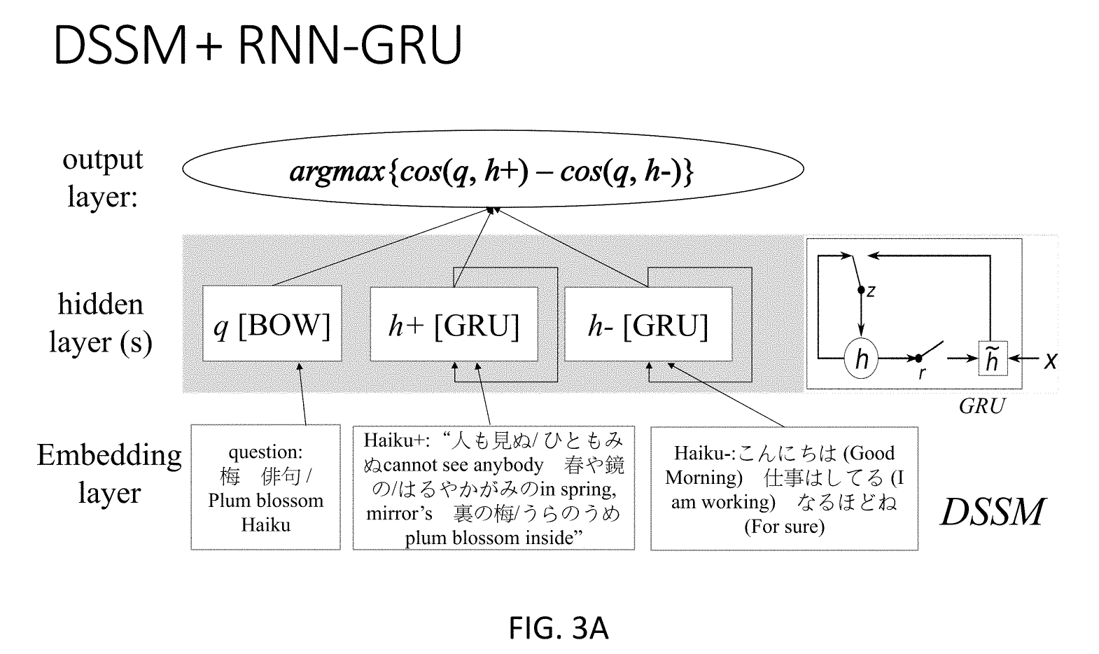

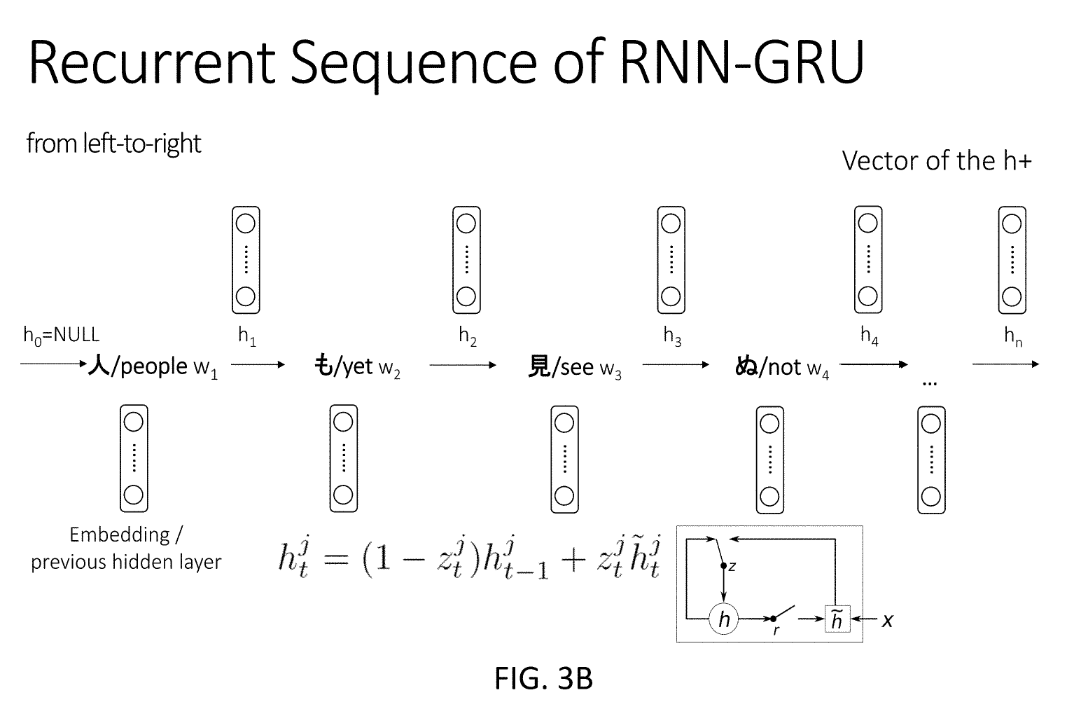

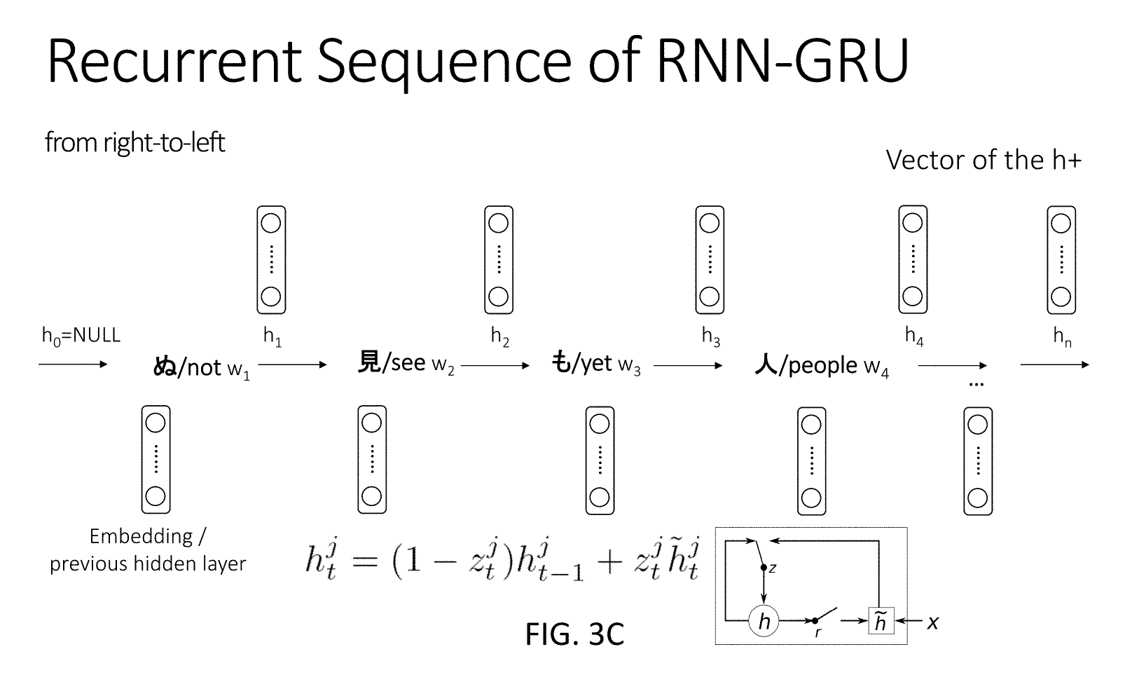

A recurrent neural network (RNN) with gated recurrent units (GRUs) to learn the similarity among a query and good/bad candidate haiku is illustrated in FIG. 3A. As illustrated in FIG. 3A, there are three layers in this DSSM network, which are listed below:
1. Embedding layer, which makes use a word2vec model that project sparse words into dense space vector representations;
2. Hidden layers, which makes use of RNN-GRUs to construct word order sensitive dense space vectors for the good Haiku (h+) and for the bad Haiku (h−); note that since the input query is a list of words and is not word order sensitive (i.e., the order of “word1 word2” or “word2 word1” do not mater (are similar with each other) in query), we thus do not use RNN-GRU for queries but only use a simple bag-of-words method to add up all the vectors from the words in a query and then take the accumulated vector as the dense space vector representation of the query. Refer to FIG. 3B as an example;
3. Output layer, which takes dense space vectors from q, h+ and h− from the hidden layer and then use cosine function to compute the margin between cos(q, h+) and cos(q, h−). Using large-margin training, the error function is a maximum of the distance between cos(q, h+) and cos(q, h−).

In FIG. 3A, one training sample includes three elements: a query; a good candidate haiku; and bad candidate haiku. For example, a haiku request query 132 of, “Plum blossom Haiku”, a good candidate haiku of “cannot see anybody; in spring's mirror; plum blossom inside”, and a bad candidate haiku of, “good morning; I am working; for sure,” is listed in FIG. 3A. The embedding layer maps these input one-hot expressions into dense vector representations. Then the hidden layer will further make use of GRU to compute the sequence level representations for the query and two candidate haikus. The output layer will compute the margin between the similarity of <query, haiku+> and <query, haiku−>. The benefit of this network is that a sparse space of variant sentences can be projected into some dense spaces and then some vector-based computing can be performed to simply compute the “similarity” among queries and haikus.

With large-margin training, the embedding matrices from words to vectors, and the transform matrices from embedding vectors to hidden layer lower-dimension vectors can be obtained. When these matrices are obtained, the testing process can be then performed. Given a query and a corresponding haiku, the training can go through the network to compute the similarity of the query and the haiku to obtain a similarity score. FIG. 3B illustrates a left-to-right expedition of the query sequence by using GRU formula shown in FIG. 3A for the forward process. FIG. 3C illustrates a right-to-left expedition of the query sequence by using GRU formula shown in FIG. 3A for the forward process. For example, Japanese is a subject-object-verb (SOV) language and the semantic meaning of the sequence cannot be determined until looking at the total sequence because the predicate is mostly located in the right-hand-side of the whole sequence. Thus, it is important to compute the vector of sequence in a right-to-left order in addition to the left-to-right manner. This similarity score will be taken as a similarity feature to be used by the GBDT algorithm for learning-to-rank (LTR) the haikus in the user haiku database 118 or the world haiku database 120.

Next, the query-haiku similarity system 116 analyzes the calculated relevance scores and selects one or more haikus from the candidate haikus with the highest scores to provide in reply to the haiku request query 132. In some aspect, the query-haiku similarity system 116 selects a predetermine number of haikus. The predetermined number may be configured by the creator of the chat bot 100 and/or selected by the user of the chat bot 100. As discussed above, the core worker 111 may collect the one or more selected haikus from the query-haiku similarity system 116 and provide the haikus to the user in reply to the haiku request query 132.

As discussed above, the haiku chat bot 100 may select an image that relates to the selected haiku and/or a generated haiku and display both the image and the selected or generated haiku together in reply to a collected a user's request for a haiku 132 or to a collected user's request to generate a haiku. In some aspects, the haiku chat bot 100 utilizes an image-haiku similarity system 112 to determine an image related to a generated or selected haiku.

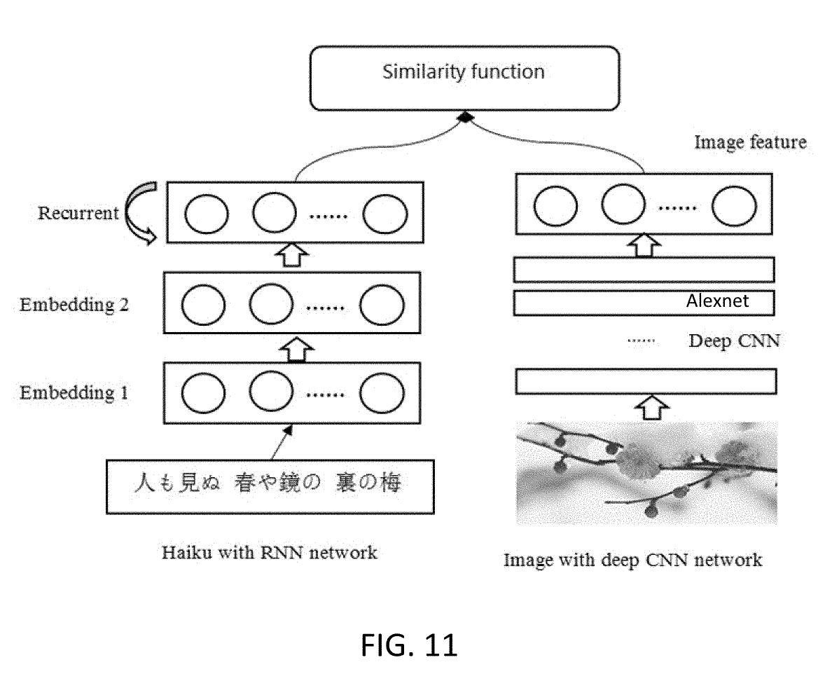

FIG. 11 is a schematic diagram illustrating a framework of an image-haiku similarity system 112, in accordance with aspects of the disclosure. The image-haiku similarity system 112 may utilize a deep Convolutional Neural Network (CNN) together with a Recurrent Neural Network (RNN) (also referred to herein as “joint CNN-RNN networks) to collect an image (from an image database 124 via a network 113) that is suitable for a given haiku. The collected image together with the selected or generated haiku are combined together and provided to the user.

The image is collected from an image database 124. In some aspects, the image database 124 is searched for images based on a selected or generated haiku utilizing a search engine to determine images that related to the selected and/or generated haiku. In some aspects, the image database 124 is searched for images that relate or correspond to any haiku saved or stored in a haiku database, such as the world haiku database 120 and/or the user haiku database 118. In some aspects, the image database 124 is searched based on a key feature of the haiku. The images returned from the search of the image database 124 are input into the CNN model. The CNN model (right-hand-side) is used to project an image into a dense vector space and the RNN model (left-hand-side) is used to project a Haiku into another dense vector space. Both the CNN model and the RNN model make use of latent semantic space. Next, the similarity between the CNN vector and the RNN vector is computed. The similarity may be computed utilizing a similarity model. In some aspects, the similarity model is a deep semantic similarity model. The similarity model is used to collect the best related images from one or more image databases 124 via a network 113 for a given haiku with the closest semantic similarity. As such, an image is selected from the collected images from the haiku database with the closest semantic similarity to the given haiku. The image and the haiku are combined and provided to the user by the image-haiku similarity system 112. In some aspects, the CNN-RNN similarity model is trained utilizing world user feedback. In these embodiments, haikus paired with corresponding images are collected and utilized as positive or negative training data for the CNN-RNN similarity model. In some aspects, the haikus paired with image training data is reviewed, selected and/or approve by a human.

As discussed above, the user request for a haiku 132 may include an image instead of text. In these aspects, the image-haiku similarity system 112 is utilized to extract a key feature from the image. For example, the CNN model (on the right-hand-side of FIG. 11) may be utilized to extract one or more key features from the image provided in the user's request for a haiku 132. The one or more key features are then provided to the query-haiku similarity system 116 for selection of a haiku from a database.

As discussed above, the haiku chat bot 100 is further capable of generating a new haiku or completing a started haiku in response to a request or query to complete/generate a haiku 134 from the user 102. The request or query to complete/generate a haiku 134 may include an image or start of a haiku from the user 102. If the query to complete a haiku 134 includes the start of a haiku, the haiku generation system 114 is utilized to complete the haiku.

As discussed above, the haiku generation system 114 may utilize a learning model to select and combine three different sentences with assigned Kanji-Kana pronunciations of 5, 7, and 5 in that order from a user haiku database 118 and/or a world haiku database 120. In some aspects, the haiku generation system 114 utilizes a recurrent neutral network language model (RNNLM) to combine the different haiku sentences to create the haiku as illustrated in FIG. 10. In further aspects, the haiku generation system 114 utilizes a bi-directional RNNLM to combine the different haiku sentences to create a haiku.

While the RNNLM of the haiku generation system 114 discussed above is trained to predict the next sentence or line in the haiku, a RNNLM of the haiku generation system 114 may also be trained to predict the next word in a sentence for generating a sentence or line in the haiku. In these aspects, the recurrent neural network and related equation for each layer of the recurrent neural network as shown in FIG. 10 is trained on a word-level instead of a sentence level to predict the next word in a sentence generation for a haiku. For example, given words “A” and “B”, the RNNLM of the haiku generation system 114 may be utilized to find the next word “C” for the sentence. Next, the RNNLM will predict the next word given the inputs of words “ABC” until the sentence reaches the appropriate 5 or 7 Kanji-Kana pronunciation.

For example, FIG. 2D illustrate a haiku generation request 134 of “complete a haiku that starts with ‘Good Morning’”. In this example, the haiku generation request 134 includes a sentence or first line with 5 Kanji-Kana pronunciation (based on Japanese language). As such, the haiku generation system 114 completes the haiku by generating second and third lines for the provided first line by the user by utilizing the RNNLM illustrated in FIG. 10. In this example, the haiku chat bot 100 provide three different generated haikus 138 that have maximum probabilities based on the RNNLM to the user in response to the haiku generation request 134 of “complete a haiku that starts with ‘Good Morning’”. For example, the RNNLM may give a candidate haiku and the score of the candidate haiku, such as P(C|A, B), A and B are given sentences, and C is the candidate with a score. As discussed above, the haiku generation system 114 will select the next word or sentence from words and/or sentences saved in the user haiku database 118 and/or world haiku database 120. Similar to the discussion above, the haiku generation system 114 may select a database based on similarity and/or a threshold comparison. In other aspects, the haiku generation system 114 automatically utilizes a default database.

If the query to complete a haiku 134 includes an image, the CNN model (on the right-hand-side of FIG. 11) may be utilized to generate a new haiku based on the image. The CNN model may include an AlexNet deep CNN model for dense embedding of an image. This AlexNet deep CNN network may include five convolutional layers, three fully connected layers and an output layer that is a 1000-way softmax which reflects 1000 target labels (in text). Since the target of the AlexNet deep CNN is to project an image into a dense vector space and then use the dense vector space representation for haiku similarity computing, the AlexNet deep CNN will ignore the final softmax layer and directly use the dense output from the second fully connected layer.

In other words, the CNN model will receive an image, generate an image feature vector (with numerous dimensions) based on the that image and then predict a first word of the haiku utilizing image features vector as an input into the RNN model of the haiku generation system 114, such as the RNN model illustrated in FIG. 10. Next, the RNN model predicts a second word based on the feature vector and the first predicted word. This process continues until the sentence or line of the haiku meets or reaches the appropriate 5 or 7 Kanji-Kana pronunciation. The RNN model then predicts another word for the next line or the entire next line based on the formed haiku line by the RNN model and the image feature vector. In some aspects, the one or more image features are based on pixels and do not include any keywords. This process continues until an entire haiku is generated by the haiku generation system 114 based on the image. The generation system combines the generated haiku and the collected image from the user and provides the combined image and haiku to the user in reply to the haiku generation request 134. Similar to above, the generation system may extract words and/or lines from the user haiku database 118 and/or the world haiku database 120. As such, the new haiku generated or completed from by the haiku generation system may be from words and/or lines listed in the user haikus stored in the user haiku database 118 and/or from words and/or lines stored in the world haiku database 120.

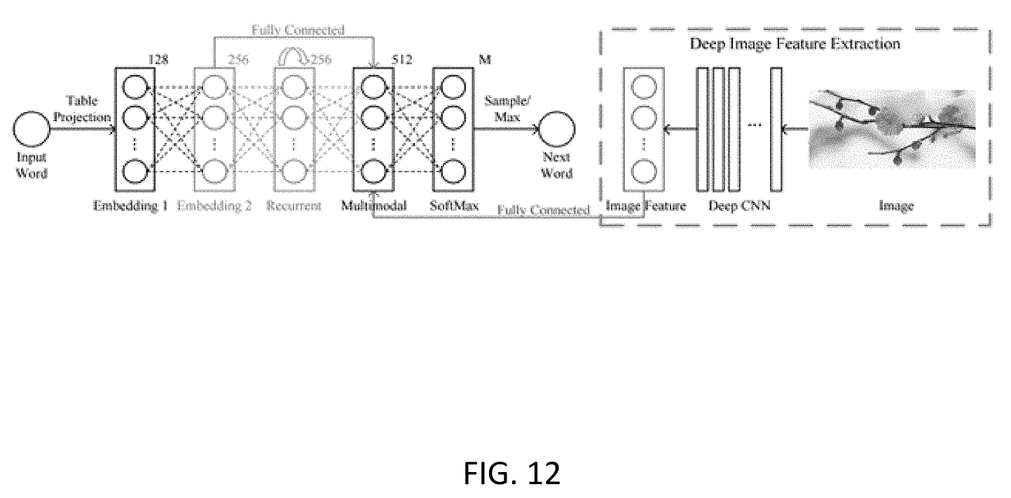

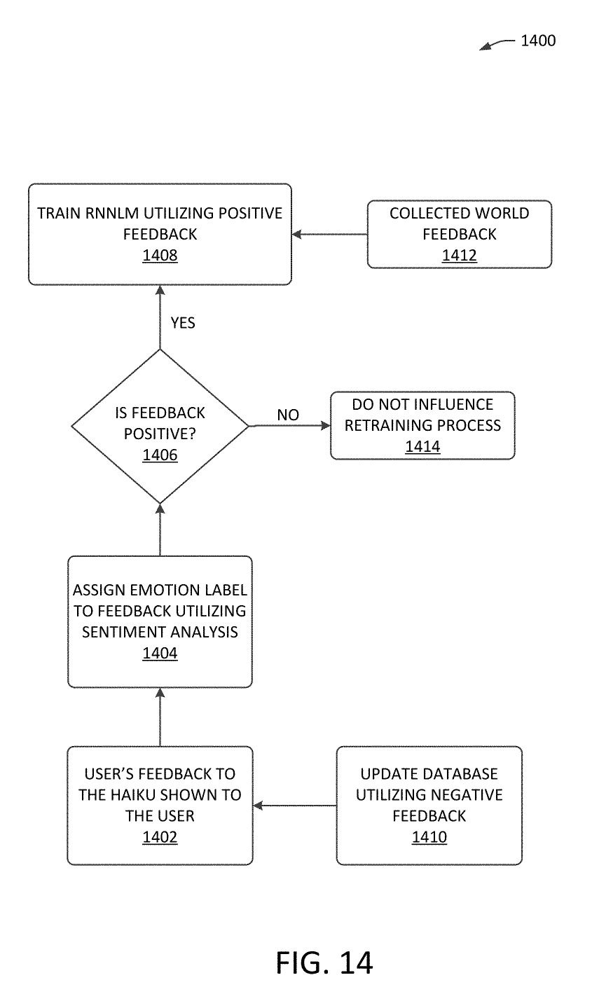

For example, FIG. 12 is a schematic diagram illustrating a framework for a haiku-image generation model for the haiku generation system 114, in accordance with aspects of the disclosure. The haiku generation system 114 may first, start from a sentence start flag “<s>”. The RNN model (as shown in FIGS. 10 and 14) of the haiku generation system 114 may calculate the probability distribution of the next word (range over all the words in the haiku vocabulary database 118 and/or 120), that is P(wi|w1, . . . , wi−1, Image). Where “wi” is the “current word candidate” and” w1 to wi−1” are the generated words (as history). The probability of each “wi” is computed in the “SoftMax” layer as illustrated in FIG. 14. After prediction of “wi”, the haiku generation system 114 takes this picked word as input to the “Input Word” layer as illustrated in FIG. 14 and continues the generation process until the model outputs the sentence end flag of “</s>”. For the “Multimodal” layer of the RNN, the input includes dense vector space representation of previous words generated and also the dense representation of the right-hand-side image. The “SoftMax” layer will help choose one proper “next word” from the haiku databases.

As discussed above, the haiku chat bot 100 may include a haiku scoring system 115 for scoring a haiku. The scoring system 115 assigns a quality score to a haiku, which indicates whether the quality of the haiku is good or bad. The haiku may be input from the user 102, generated by the haiku chat bot 100, and/or collected from the world haiku database 120 and/or the user haiku database 118. In some aspects, the haiku scoring system 115 scores a haiku in response to collecting a request to score a haiku 136 from a user 102. In other aspects, the haiku scoring system 115 scores any collected haiku by the chat bot 100. The request or query 136 may include the haiku that is requested to be scored by the user 102 or a haiku that is referenced by the user.

The haiku scoring system 115 analyzes one or more evaluation features for each haiku. The evaluation features may include the sentence level similarity between the three lines of the haiku from the RNNLM model (or sentence similarity score or semantic distance), the word level cosine similarity between the words in the haiku from the RNNLM model (or word similarity score or word semantic distance), whether the end words of each line rhyme, and/or the average word frequency. Word frequency as utilized herein refers to how common (or frequently) or uncommon (how infrequently) a word is utilized in common speech patterns. For example, the word “hiccup” is utilized more often than the word “singultus.” As such, the word “hiccup” will have a higher frequency score than the word “singultus”. The haiku scoring system 115 of the haiku chat bot 100 averages the frequency score of all of the words in the haiku. Each evaluation feature may have identified thresholds or scores, such that haikus that fall within a specific range or level of that evaluation features will receive a weight or score. The scores and/or weights of each evaluation feature are then evaluated and utilized to provide a quality score for the haiku.

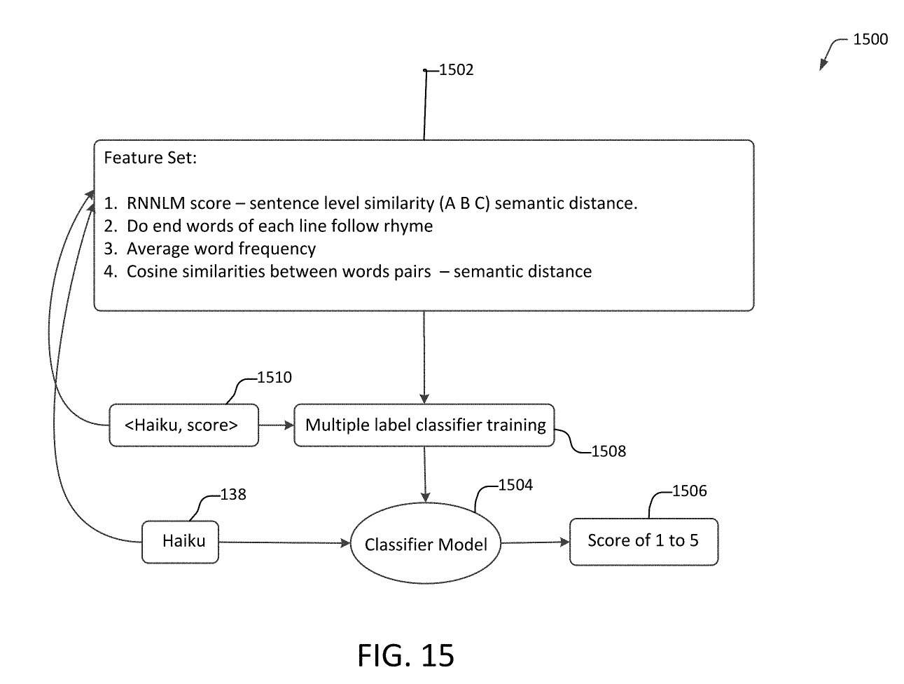

For example, FIG. 15 is a schematic diagram of a work flow 1500 for a haiku scoring system 115, in accordance with aspects of the disclosure. As illustrated in FIG. 15, the haiku scoring system 115 collects a haiku 138 for scoring in response. The haiku scoring system 115 evaluates the haiku 138 to determine the scores or weight for the one or more evaluation features 1502 utilizing a classifier model 1504. The classifier model 1504 evaluate the scores or weight of the determined evaluation features to determine a quality score 1506 for the collected haiku 138. The classifier model 1508 may be trained 1508 utilizing collected already scored haikus 1510. The collected already scored haikus 1508 or the training data for the classifier model 1504 may include scored evaluation features for the already scored haikus 1508. In some aspects, the haiku scoring system 115 utilizes a scale of 1-5 or 1-10. However, any suitable scoring scale may be utilized by the haiku scoring system for informing the user about how good or bad is a collected haiku. In further aspects, the evaluation features all utilizes the same scoring scale. In further aspects, the evaluation features utilize the same scale as the haiku scoring system for scoring the haiku.

In some aspects, the haiku scoring system 115 includes comments about the collected haiku in addition to the haiku score 1506. In some aspects, the comments are predetermined by haiku experts with gaps for words or phrases to be extracted from the collected haiku. For example, the predetermined comment may be a gapped sentence of, “Well done! The relation between [word 1] and [word 2] is really good and this type of dependency is excellent!” In this example, word2vec is utilized to compute the cosine similarity of each word pair in the Haiku and score the pairs based on the similarity. The word pair with the highest cosine similarity score are then inserted into the [word 1] and the [word 2] gap of the sentence above and presented to the user with haiku score by the haiku scoring system 115.

For example, FIG. 2E shows a user interface with a user request to score a provided haiku 136. In response to the request 136, the haiku chat bot 100 provides a score 144 of 4 out of 5 and a well done predetermined comment 142 based on the collected haiku that indicates that relationship between the words “evidence” and “love” in the provided haiku is very good.

The chat bot 100 also includes a feedback system 119. The feedback system 119 utilizes user feedback and/or world feedback 122 to train or update the models utilized by the query-haiku similarity system 116, the haiku generation system 114, the haiku scoring system 115, and/or the image-haiku similarity system 112. In some aspects, the feedback system 119 utilizes user feedback and/or world feedback 122 to train the RNN model, RNNLM, the CNN model, the similarity model, the RNN-CNN similarity model, and/or a classifier model.

In some aspects, the feedback system 119 collects world feedback 122 via a network 113. The world feedback 122 may include haikus and corresponding scores and/or evaluated features, haiku generation/completion requests 134 with corresponding generated/completed haikus based on this request 134, and haiku selection requests 132 with corresponding selected haikus based on this request 132 from other users of the chat bot 100 that can be utilized as positive or negative training data for the query-haiku similarity system 116, the haiku generation system 114, the haiku scoring system 115, and/or the image-haiku similarity system 112 of the chat bot 100.

In other aspects, the feedback system 119 collects user inputs provided in in reply to a selected, generated and/or scored haiku by the a haiku chat bot 100. The feedback system 119 analyzes these user answers to determine user feedback for the haiku chat bot 100 provided selected haiku, generated haiku, and/or scored haiku. The feedback system 119 utilizes the determined user feedback as positive or negative training data for models utilized by the query-haiku similarity system 116, the haiku generation system 114, the haiku scoring system 115, and/or the image-haiku similarity system 112.

In some aspects, the user feedback is analyzed to determine the sentiment of the feedback or the emotion of the user during the providing of the feedback. The feedback system 119 may utilizing a sentiment analysis classifier or model that collects and analyzes the user feedback to determine an emotion for the feedback. In some aspects, the sentiment analysis model determines if the emotion of a feedback is positive or negative. In other aspects, the sentiment analysis model determines if the emotion for the feedback is positive, negative, or neutral. The sentiment model receives the text input of the feedback and outputs an emotion label for the feedback that is representative of the emotion of the user 102 for that feedback. The emotion label may be assigned utilizing a simple heuristic rule so that a positive emotion for feedback receives a score or emotion label of 2, a neutral feedback receives a score or label or 1, and a negative feedback receives an emotion label or score of −1. A feedback with an assigned emotion label may be referred to herein as a labeled feedback. The sentiment model may identify an emotion label by utilizing one or more the following features:
Word ngrams: unigrams and bigrams for words in the text input;
Character ngrams: for each word in the text, character ngrams are extracted, for example, 4-grams and 5-grams may be utilized;
Word skip-grams: for all the trigrams and 4-grams in the text, one of the words is replaced by * to indicate the presence of non-contiguous words;
Brown cluster ngrams: brown clusters are utilized to represent words (in text), and extract unigrams and bigrams as features;
Part-of-speech (POS) tags: the presence or absence of part-of-speech tags are used as binary features;
Lexicons: the English wordnet Sentiment Lexicon may be utilized;
Social network related words: number (in text) of hashtags, emoticons, elongated words, and punctuations are may also be utilized; and
Word2vec cluster ngrams: Word2vec tool may be utilized to learn 100-dimensional word embedding from a social network dataset, next a K-means algorithm and L2 distance of word vectors is employed to cluster the million-level vocabulary into 200 classes that represent generalized words in the text.
   A multiple class support vector machine (SVM) model is trained utilizing these features to determine the sentiment of each user feedback. In some aspects, the sentiment model may also utilize sound-based sentiment analysis for any received recorded voice feedback of the applicant to judge how positive the applicant is during the feedback. Feedback that is assigned a positive emotion label may be utilized by the feedback system as positive training data, while feedback assigned a negative emotion label may be utilized as a negative training data by the feedback system 119. Feedback that is assigned a neutral label by the feedback system 119 may not be utilized as training data, may be utilized as positive training date, or utilized as negative training depending on the configuration of the feedback system 119.

For example, FIGS. 2B and 2C each show that the user provided feedback 143 in reply to the chat bot provided haiku 138 and picture 140. The feedback 143 provided by the user 102 in FIGS. 2B and 2C is positive and utilized as positive training data by the feedback system 119 since the user responds by reciting, “The figure with snow and plum blossom quite fits with the Haiku on-top-of the figures!” and “The figure with snow and plum blossom quite fits with the Haiku on-top-of the image!”.

In another example, in FIG. 2D the user provided feedback 143 in reply to the chat bot provided haikus 138. The feedback 143 provided by the user 102 in FIG. 2D is positive for the third provided haiku and negative or neutral for the first and second provided haikus by the haiku chat bot since the user responds 130 by reciting, “The third Haiku is the best one!”. This user feedback provides a positive emotion label for the third Haiku and neutral or potentially negative emotion labels for the first and second haikus.

If the feedback system 119 determines user feedback, the feedback system 119 will send the user feedback to the appropriate system and/or model as training data. If the feedback system 119 does not determine any user feedback, the feedback system 119 will not send any data to any system and/or model as training data.

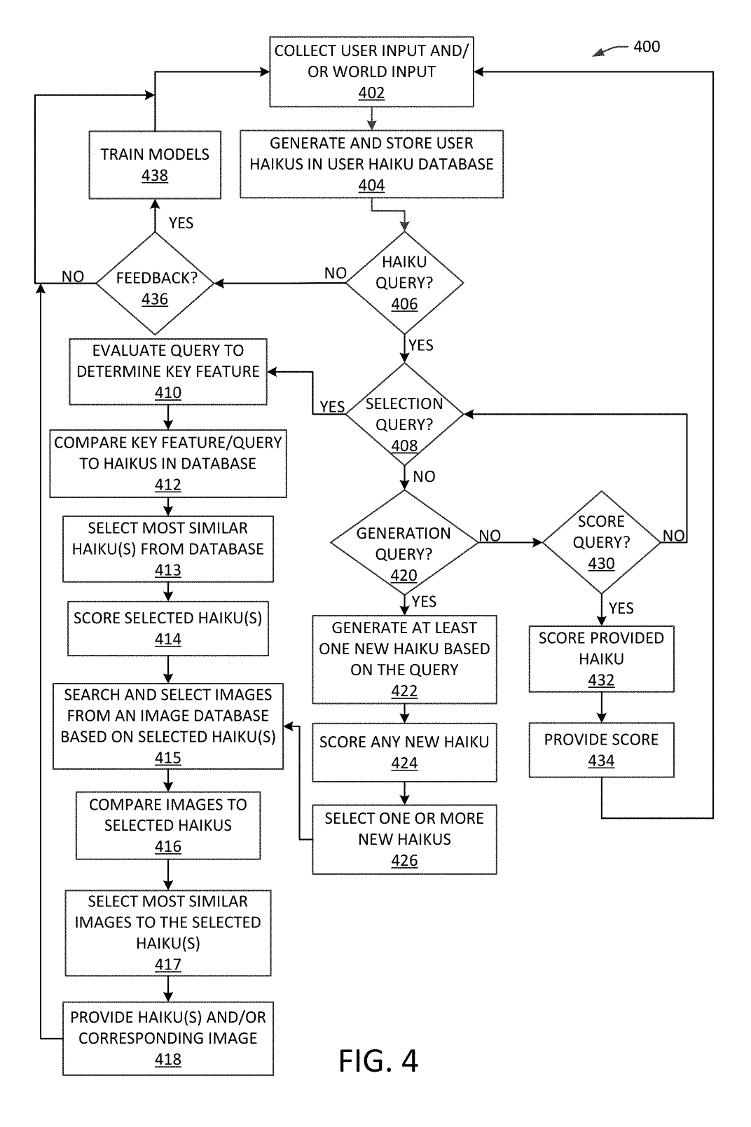

FIG. 4 illustrates a flow diagram conceptually illustrating an example of a method 400 for automated haiku chatting. In some aspects, method 400 is performed by an application, such as the chat bot 100 or a digital assistant containing the chat bot 100 as described above. Method 400 provides automated haiku chatting that selects, generates, and/or scores a haiku from various different user inputs, such as images. Further, method 400 may utilize bi-directional deep learning analysis to generate, select, and/or score a haiku from various different user inputs, such as images. In some aspects, method 400 is capable of generating and/or selecting a haiku that is created from user inputs previously collected by method 400. Further, method 400 is capable of providing an image along with a selected or generated haiku that relates to the selected and/or generated haiku. As such, method 400 performs automated haiku chatting that is more effective, more engaging, and/or easier to use than previously utilized haiku chat bots that were not able to provide images with haiku results, generate new haikus from a collected image, generate haikus from the user's own inputs, and/or utilize deep learning analysis in both directions.

Method 400 starts at operation 402. At operation 402, a user input is collected. In some aspects, world input is collected at operation 402. The input may be provided in one or more different modalities, such as video, voice, images, and/or texts. The user inputs may be collected from an application running method 400 or from one or more applications in communication with the application running method 400. In some aspects, at operation 402 the input is processed or converted into text. In some aspects, a LU system with one or more different APIs is utilized to convert the received user input into text and/or annotated text. The world input may be collected from one or more databases, such data or information from an image database, a world haiku database, and/or a world feedback database.

At operation 404, the user input is analyzed to generate one or more haikus from the user input. The haikus generated from the user input are stored in a user haiku database at operation 404. If very little or no user inputs have been collected at operation 402, there may be no or very little haikus generated from the user input at operation 404. As such, the more inputs provided at operation 402 the larger the number of haikus generated from the user inputs stored in the user haiku database.

At operation 406, the user input is evaluated to determine if the input is a haiku query. If the user input is a haiku query then operations 408, 420, and/or 430 are performed. Operations 408, 420, and/or 430 may be performed in any desired order and are directed to determining the kind or type of haiku query provided in the user input. In other aspects, operations 408, 420, and/or 430 may be performed as one operation. In further aspects, operations 408, 420, and/or 430 may be performed by a core worker 111. If the user input is not a haiku query, then operation 436 is performed. The haiku query may be a request form the user to provide a haiku, to generate or complete a haiku, and/or to score a haiku. In some aspects, a core worker may evaluate the user input to determine if the input includes a haiku query.

At operation 408, a determination is made whether the haiku query is a request to provide haiku. If a determination is made that the haiku query is not a request to provide a haiku at operation 408, then operations 420 and/or 430 are performed. If a determination is made that the haiku query is a request to provide a haiku at operation 408, then operation 410 is performed. In some aspects, the request to provide a haiku includes text and/or an image. In some aspect, operation 408 determines that a user input is a request to provide haiku based on detected trigger words in the input.

The request to provide a haiku is evaluated to determine a key feature at operation 410. In some aspects, the request to provide a haiku does not include a key feature. In these aspects, a key feature is not determined and the query is labeled as a generic haiku request at operation 410. In some aspects, the request to provide a haiku includes an image. In these aspects, the image is evaluated to determine one or more image features of the image at operation 410. In some aspects, the image is evaluated utilizing a deep CNN model to determine the one or more features of the image at operation 410. In other aspects, the text in the request to provide a haiku is evaluated utilizing a RNN model to determine a key feature of the text.

After operation 410, operation 412 is performed. At operation 412, the key feature(s), if identified, and/or the query is compared to haikus in on or more databases. In some aspects, the haiku query and/or the key feature(s) are compared to determine the semantic similarity between the haiku in the database and the key feature(s) and/or haiku query.

Next, at operation 413 haikus from the one or more databases that are the most similar to the query and/or the key features are selected from the one or more databases. In some aspects at operation 413, haikus are selected that meet a predetermined semantic similarity threshold with the query and/or features. In other aspects, a predetermined number, such as 1, 2, 3, and 5, of haikus with highest semantic similarity scores to the query and/or key feature(s) are selected from the one or more databases. In some aspects, if the query does not include a key feature, the one or more haikus selected from the one or more databases may be selected at random. In others aspects, one or more haikus are picked at random the haikus that meet a predetermined semantic similarity threshold with the query and/or features at operation 413.

The one or more databases may be a user haiku database, which contains haikus generated from collected user inputs. The one or more databases may be a world haiku database that contains known publically available haikus. In some aspects at operations 412 and 413, both the user haiku database and the world haiku database are utilized. In other aspects, the world haiku database is only utilized at operation 412 and 413 if none of the user haikus meet a semantic similarity threshold with the query and/or key features. In alternative aspects, the world haiku database is only utilized at operation 412 and 413 if the key feature does not meet an input threshold. The input threshold represents the amount of user input collected that relates to a key feature. User haikus for any given key feature can only be generated and saved to the user haiku database in response to receiving a predetermined amount user input relating to that key feature. As such, if the input for a given key feature is below the input threshold, the user haiku database will not include any user haikus for that key feature.

In some aspects, method 400 includes operation 414. At operation 414, the selected haikus from the one or more database are evaluated and assigned a haiku score. The selected haikus may be evaluated utilizing one or more evaluation features as discussed above. In some aspects, if the query does not include a key feature, each haiku in the one or more databases may be scored at operation 414, and the one or more haikus selected from the one or more databases at operation 413 may be selected based on the highest haiku score.

In some aspects, method 400 determines an image that corresponds to a selected or generated a haiku and provides the selected or generated haiku in combination with the determined corresponding image. In these aspects, method 400 includes operations 415, 416, and/or 417. If an image is included in the haiku query (generation or selection request), then method 400 does not include operations 415, 416, and/or 417.

At operation 415, an image database is searched to find one or more images that related to a selected or a generated haiku. In some aspects, the search of the image database is based on one or more keywords or features from the selected and/or the generated haiku. The images may be collected from the image database utilizing a search engine at operation 415.

At operation 416, the collected images from operation 415 for a given selected and/or generated haiku are each compared to the selected and/or generated haiku at operation 416. In some aspects at operation 416, the collected images from operation 415 are each compared to the selected and/or generated haiku to determine an image with the highest similarity (such as semantic distance) to the selected and/or generated haiku at operation 416.

Next, at operation 416 images from the one or more image databases that are the most similar to the selected and/or generated haiku are selected from the collected images. In some aspects at operation 416, an image is chosen for a selected and/or generated haiku that has the highest semantic similarity score.

At operation 418, the selected one or more haikus from operation 413 or the one or more generated haikus from operation 426 are provided to the user. In some aspects, the one or more selected or generated haikus include a corresponding image collected from operation 417. In some aspects, the one or more selected or generated haikus are provided by a client computing device to the user at operation 418. In other aspects, instructions are sent to the client computing device to provide the one or more selected or generated haikus to the user at operation 418. The client computing device provides the one or more selected or generated haikus utilizing any known visual, audio, tactile, and/or other sensory mechanisms at operation 418. For example, the client computing device may provide the one or more selected or generated haikus through visual display on a display screen on the client computing device.

At operation 420, a determination is made whether the haiku query is a request to complete or generate a haiku. If a determination is made that the haiku query is not a request to generate or complete a haiku at operation 420, then operations 408 and/or 430 may be performed. If a determination is made that the haiku query is a request to complete or generate a new haiku at operation 420, then operation 422 is performed. In some aspect, operation 420 determines that a user input is a request to complete or generate a haiku based on detected trigger words in the input.

At operation 422, the request to complete or generate a haiku is evaluated to generated or complete one or more new haikus. The words and/or lines utilized to generate or complete a haiku are extracted from already formed haikus stored on one or more haiku databases. As such, the newly created or generated haikus will be comprised of words and/or lines extracted from haikus contained in the one or more database. The one or more databases may be a user haiku database and/or a world haiku database. For example, if the user haiku database is utilized, the newly generated haiku will be comprised of words and/or lines extracted from user haikus created from collected user inputs.

In some aspects, the haiku query (the request to complete or generate a haiku) includes text and/or an image. In aspects wherein the request to complete or generate a haiku includes an image, the image is evaluated to determine one or more features of the image at operation 422. In some aspects, the image is evaluated utilizing a deep CNN model to determine the one or more features of the image at operation 422. In some aspects, the haiku query (the request to complete or generate a haiku) includes one or more lines of a haiku. In other aspects, the haiku query (the request to complete or generate a haiku) includes one or more words from one or more lines of a haiku.

In some aspects at operation 422, the haiku is completed or generated utilizing RNNLM model. In these aspects, the next word and/or line in the generated or completed haiku is predicted and extracted from one or more databases based on any words, lines, and/or image feature received in the request to complete or generate a haiku and any previously predicted word or line by the RNNLM model.

In some aspects, method 400 includes operation 424. At operation 424, the generated or completed haikus from the one or more databases are evaluated and assigned a haiku score. The generated or completed haikus may be evaluated utilizing one or more evaluation features as discussed above.

At operation 426 one or more of the newly generated and/or completed haikus are selected. In some aspect, each haiku generated at operation 422 is selected. In other aspects, a predetermined number of generated haikus may be selected from all the generated haikus at operation 422. In some aspects, the predetermined number may be selected at random from the all the generated haikus at operation 422. In alternative aspects, the predetermined number may be selected based on the highest haiku quality scores at operation 422.

At operation 430, a determination is made whether the haiku query is a request to score a haiku. If a determination is made that the haiku query is not a request to score a haiku at operation 420, then operations 408 and/or 420 may be performed. If a determination is made that the haiku query is a request to score haiku at operation 430, then operation 432 is performed. In some aspect, operation 430 determines that a user input is a request to score a haiku based on detected trigger words in the input.

At operation 432, a provided haiku or a referenced haiku from the one or more databases are evaluated and assigned a haiku score. The generated or completed haikus may be evaluated utilizing one or more evaluation features as discussed above. In some aspects, the haiku is scored utilizing a classifier model. In other aspects, the evaluation features and/or haiku score all utilize the same scale.

Next, at operation 434, the determined score for the reference haiku is provided to the user. In some aspects, the haiku score is provided by a client computing device to the user at operation 434. In other aspects, instructions are sent to the client computing device to provide the haiku score to the user at operation 434. The client computing device provides the haiku score utilizing any known visual, audio, tactile, and/or other sensory mechanisms at operation 434. For example, the client computing device may provide the haiku score through visual display on a display screen on the client computing device and audibly through a speaker.

As discussed above, if the collected user input is not a haiku query, then operation 436 is performed. At operation 436, the user input is evaluated to determine if the input includes feedback. If a determination is made that the input does not include feedback at operation 436, then method 400 ends or restarts at operation 402. If a determination is made that the input includes feedback at operation 436, then operation 438 is performed.

At operation 438, the feedback is sent to one or more models utilized by method 400 to update or train those models based on the feedback. After the performance of operation 438, operation 402 may be performed again or method 400 may end.

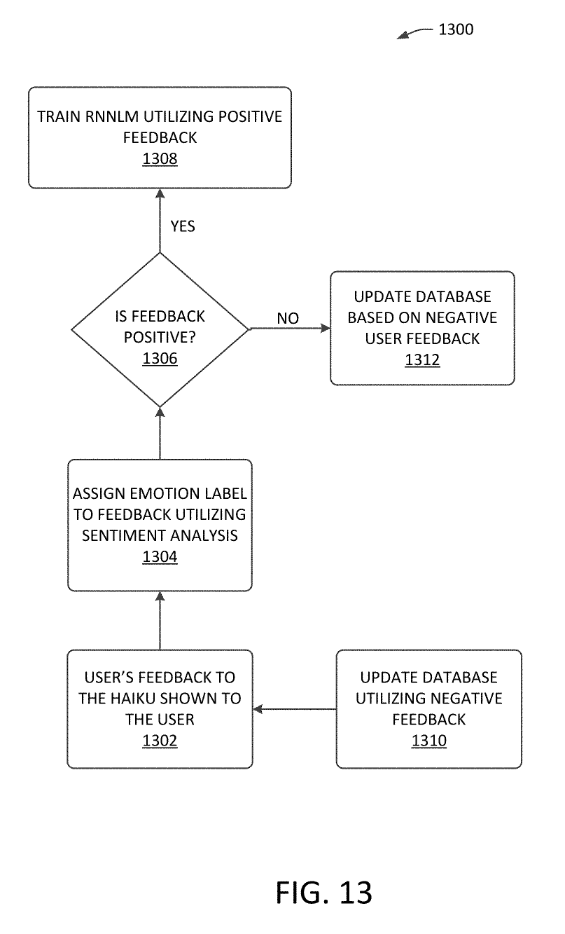

For example, FIG. 13 is a block flow diagram for a method 1300 for training a similarity model utilizing feedback, in accordance with aspects of the disclosure. Method 1300 illustrates a specific example of operations 436 and 438 discussed above. In this example, the user feedback is collected at operation 1302. Next, an emotion label is assigned to the user feedback utilizing sentiment analysis at operation 1304. At operation 1306, the emotion label is evaluated to determine if the emotion label is positive. If a determination is made that the emotion label is positive at operation 1306, operation 1308 is performed. If a determination is made that the emotion label is negative at operation 1306, operation 1310 is performed.

At operation 1308, the positive training data is sent to the RNNLM to reinforce the prior response. At operation 1310, the negative training data is utilized to update a database, such as the user haiku database. If the negative training is based on a provided user haiku, the provided user haiku is deleted from the user haiku database at operation 1310. If the negative training is based on a provided a publically known haiku collected from a world haiku database, a flag is added to a database indicating that the previously provided haiku should not be collected from a world haiku database again at operation 1310.

In another example, FIG. 14 is a block flow diagram for a method 1400 for training a haiku-image similarity model utilizing feedback, in accordance with aspects of the disclosure. Method 1400 illustrates a specific example of operations 436 and 438 discussed above. In this example, the user feedback is collected at operation 1402. In this example, world feedback is collected at operation 1412. The world feedback includes positive or known good haiku and image pairs. After operation 1402, operation 1404 is performed. At operation 1404, an emotion label is assigned to the user feedback utilizing sentiment analysis. At operation 1406, the emotion label is evaluated to determine if the emotion label is positive. If a determination is made that the emotion label is positive at operation 1406, operation 1408 is performed. If a determination is made that the emotion label is negative at operation 1406, operation 1410 is performed. At operation 1410, the negative training data is discarded and is not utilized to train or update the CNN-RNN similarity model and/or any databases.

At operation 1408, positive training data is collected for training the CNN-RNN similarity model. The positive training data may be the user feedback collected by operation 1402 and/or the positive world feedback collected at operation 1412. The positive user feedback may be utilized to reinforce the prior response at operation 1412. Further, any collected haiku and image pairs that are known to be good may be added to a database, such as the user haiku database.

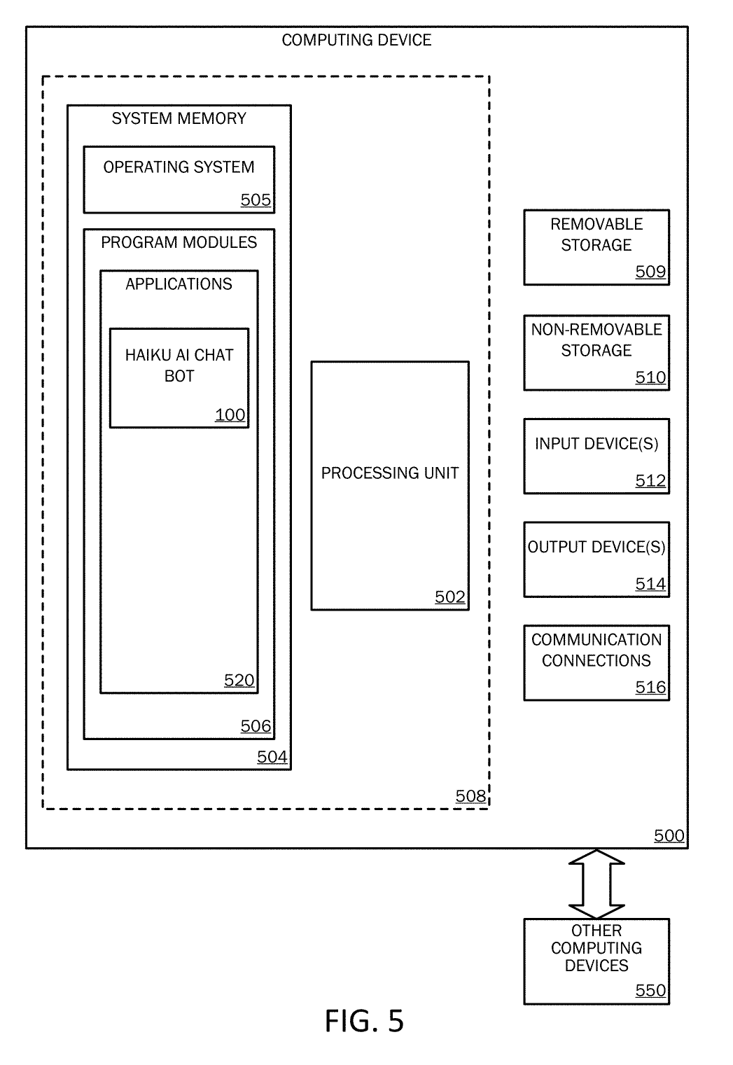

FIGS. 5-8 and the associated descriptions provide a discussion of a variety of operating environments in which aspects of the disclosure may be practiced. However, the devices and systems illustrated and discussed with respect to FIGS. 5-8 are for purposes of example and illustration and are not limiting of a vast number of computing device configurations that may be utilized for practicing aspects of the disclosure, described herein.

FIG. 5 is a block diagram illustrating physical components (e.g., hardware) of a computing device 500 with which aspects of the disclosure may be practiced. For example, the AI haiku chat bot 100 could be implemented by the computing device 500. In some aspects, the computing device 500 is a mobile telephone, a smart phone, a tablet, a phablet, a smart watch, a wearable computer, a personal computer, a desktop computer, a gaming system, a laptop computer, and/or etc. The computing device components described below may include computer executable instructions for the chat bot 100 that can be executed to employ method 400. In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combined of such memories. The system memory 504 may include an operating system 505 and one or more program modules 506 suitable for running software applications 520. The operating system 505, for example, may be suitable for controlling the operation of the computing device 500. Furthermore, aspects of the disclosure may be practiced in conjunction with a graphics library, other operating systems, or any other application program and is not limited to any particular application or system. This basic configuration is illustrated in FIG. 5 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., a core worker 111, an image-haiku similarity system 112, a haiku generation system 114, a scoring system 115, a query-haiku similarity system 116, and a user haiku database 118, and/or a feedback system 119) may perform processes including, but not limited to, performing method 400 as described herein. For example, the processing unit 502 may implement the chat bot 100, including a LU system 110, a core worker 111, an image-haiku similarity system 112, a haiku generation system 114, a scoring system 115, a query-haiku similarity system 116, and a user haiku database 118, and/or a feedback system 119. Other program modules that may be used in accordance with aspects of the present disclosure, and in particular to generate screen content, may include a digital assistant application, a voice recognition application, an email application, a social networking application, a collaboration application, an enterprise management application, a messaging application, a word processing application, a spreadsheet application, a database application, a presentation application, a contacts application, a gaming application, an e-commerce application, an e-business application, a transactional application, exchange application, a device control application, a web interface application, a calendaring application, etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip).

Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 500 may also have one or more input device(s) 512 such as a keyboard, a mouse, a pen, a microphone or other sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, RF transmitter, receiver, and/or transceiver circuitry, universal serial bus (USB), parallel, and/or serial ports.

The term computer readable media or storage media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

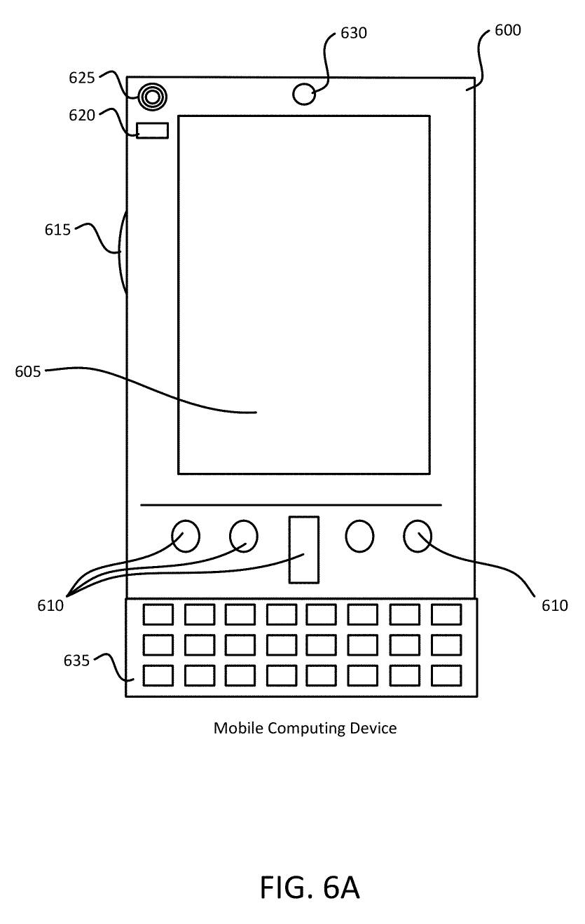

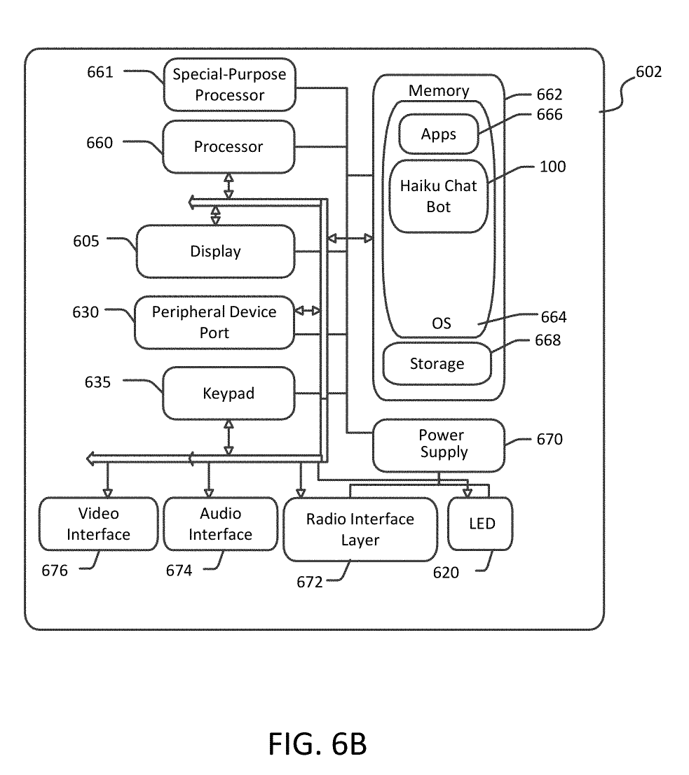

FIGS. 6A and 6B illustrate a mobile computing device 600, for example, a mobile telephone, a smart phone, a tablet, a phablet, a smart watch, a wearable computer, a personal computer, a desktop computer, a gaming system, a laptop computer, or the like, with which aspects of the disclosure may be practiced. With reference to FIG. 6A, one aspect of a mobile computing device 600 suitable for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display).

If included, an optional side input element 615 allows further user input. The side input element 615 may be a rotary switch, a button, or any other type of manual input element. In alternative aspects, mobile computing device 600 may incorporate more or less input elements. For example, the display 605 may not be a touch screen in some aspects. In yet another alternative aspect, the mobile computing device 600 is a portable phone system, such as a cellular phone. The mobile computing device 600 may also include an optional keypad 635. Optional keypad 635 may be a physical keypad or a “soft” keypad generated on the touch screen display.

In addition to, or in place of a touch screen input device associated with the display 605 and/or the keypad 635, a Natural User Interface (NUI) may be incorporated in the mobile computing device 600. As used herein, a NUI includes as any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence.

In various aspects, the output elements include the display 605 for showing a graphical user interface (GUI). In aspects disclosed herein, the various user information collections could be displayed on the display 605. Further output elements may include a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one aspect of a mobile computing device. That is, the mobile computing device 600 can incorporate a system (e.g., an architecture) 602 to implement some aspects. In one aspect, the system 602 is implemented as a “smart phone” capable of running one or more applications (e.g., browser, e-mail, calendaring, contact managers, messaging clients, games, and media clients/players). In some aspects, the system 602 is integrated as a computing device, such as an integrated personal digital assistant (PDA) and wireless phone.

One or more application programs 666 and/or the chat bot 100 run on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

The system 602 has a power supply 670, which may be implemented as one or more batteries. The power supply 670 might further include an external power source, such as an AC adapter or a powered docking cradle that supplements or recharges the batteries.

The system 602 may also include a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated aspect, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio 672 or via a distributed computing network. Similarly, such data/information may be readily transferred between computing devices for storage and use according to well-known data/information transfer and storage means, including electronic mail and collaborative data/information sharing systems.

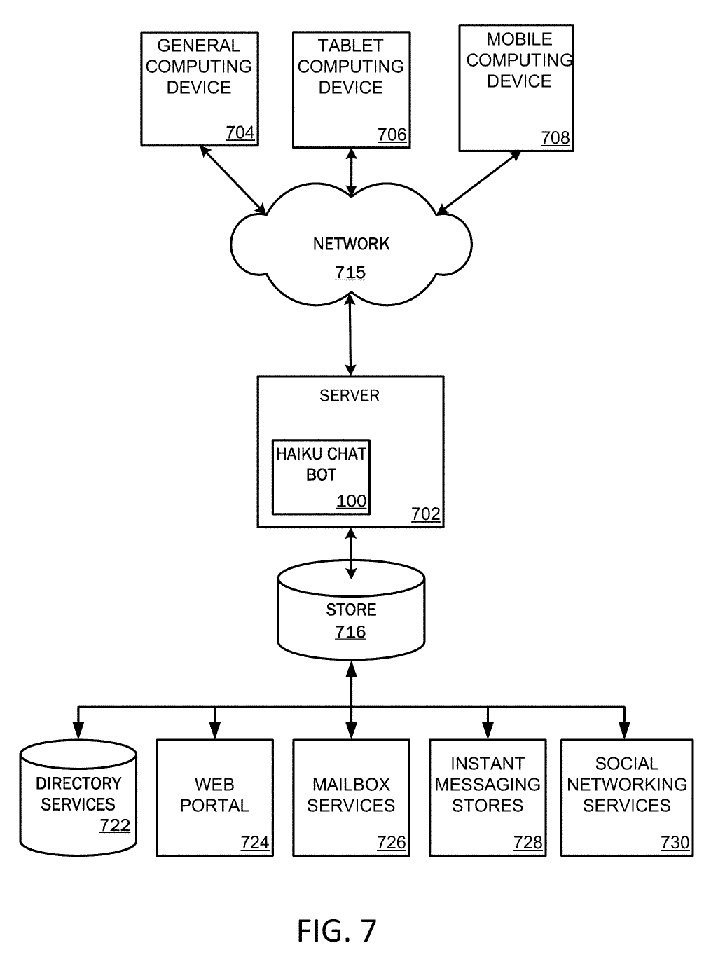

FIG. 7 illustrates one aspect of the architecture of a system for processing data received at a computing system from a remote source, such as a general computing device 704, tablet 706, or mobile device 708, as described above. Content displayed and/or utilized at server device 702 may be stored in different communication channels or other storage types. For example, various documents may be stored using a directory service 722, a web portal 724, a mailbox service 726, an instant messaging store 728, and/or a social networking site 730. By way of example, the chat bot may be implemented in a general computing device 704, a tablet computing device 706 and/or a mobile computing device 708 (e.g., a smart phone). In some aspects, the server 702 is configured to implement a chat bot 100, via the network 715 as illustrated in FIG. 7.

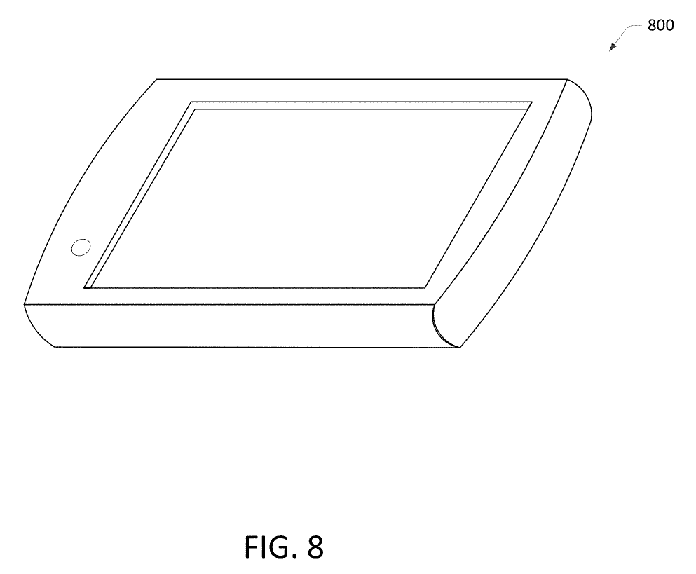

FIG. 8 illustrates an exemplary tablet computing device 800 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Embodiments of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

This disclosure described some embodiments of the present technology with reference to the accompanying drawings, in which only some of the possible aspects were described. Other aspects can, however, be embodied in many different forms and the specific embodiments disclosed herein should not be construed as limited to the various aspects of the disclosure set forth herein. Rather, these exemplary aspects were provided so that this disclosure was thorough and complete and fully conveyed the scope of the other possible aspects to those skilled in the art. For example, aspects of the various embodiments disclosed herein may be modified and/or combined without departing from the scope of this disclosure.

Although specific aspects were described herein, the scope of the technology is not limited to those specific aspects. One skilled in the art will recognize other aspects or improvements that are within the scope and spirit of the present technology. Therefore, the specific structure, acts, or media are disclosed only as illustrative aspects. The scope of the technology is defined by the following claims and any equivalents therein.

1. A system for a haiku chat bot, the system comprising:
at least one processor; and
a memory for storing and encoding computer executable instructions that, when executed by the at least one processor is operative to:
collect user inputs;
generate user haikus based on the user inputs;
store the user haikus in a user haiku database;
collect a haiku query from a user;
evaluate the haiku query to determine a key feature;
determine that the key feature meets an input threshold;
compare at least one of the haiku query and the key feature to the user haikus in the user haiku database to determine a semantic similarity;
collect a result haiku from the user haikus in the user haiku database based on the semantic similarity; and
provide the result haiku to the user in reply to the haiku query.

2. The system of claim 1, wherein generate the user haikus based on the user inputs comprises:
utilizing a deep learning semantic similarity model that includes a bi-directional recurrent neural network with gated recurrent units.

3. The system of claim 2, wherein the at least one processor is operative to:
collect user feedback from the user inputs; and
train the deep learning semantic similarity model based on the user feedback.

4. The system of claim 2, wherein the at least one processor is operative to:
collect world feedback; and
train the deep learning semantic similarity model based on the world feedback.

5. The system of claim 1, wherein the at least one processor is operative to:
collect user feedback in response to the result haiku, wherein the user feedback is negative;
delete a user haiku that relates to the user feedback from the user haiku database in response to the user feedback that is negative.

6. The system of claim 5, wherein the at least one processor is operative to:
analyze the user feedback utilizing sentiment analysis to determine that the user feedback is negative.

7. The system of claim 1, wherein each user haiku in the user haiku database is associated with a quality score.

8. The system of claim 7, wherein the at least one processor is operative to:
assign the quality score to each user haiku in response to generation of a user haiku,
wherein the quality score for each user haiku is determined based on:
semantic similarity between word pairs in the user haiku;
semantic similarity between sentences in the user haiku;
average word frequency in the user haiku; and
rhyming of sentence end words in the user haiku.

9. The system of claim 1, wherein the result haiku includes a corresponding haiku image.

10. The system of claim 9, wherein the at least one processor is operative to:
search an image database based on a first user haiku;
collect an image based on the first user haiku; and
store the image in the user haiku database paired with the first user haiku to form the corresponding haiku image.

11. The system of claim 1, wherein the haiku query is a word in text.

12. The system of claim 1, wherein the haiku query is an image.

13. A method for automated haiku chatting, the method comprising:
collecting a haiku generation query from a user, wherein the haiku generation query includes an image;
evaluating the image to determine an image feature;
evaluating the image feature to generate a new haiku, wherein words for the new haiku are extracted from at least one of user haikus in a user haiku database or from known haikus in a world haiku database and combined to form the new haiku; and
providing the new haiku to the user in reply to the haiku generation query.

14. The method of claim 13, wherein evaluating the image to determine the image feature utilizes a convolution neural network for extraction of the image feature and for image feature to vector projection.

15. The method of claim 14, wherein evaluating the image feature to generate the new haiku utilizes a recurrent neural network to determine a probability of a next word in generation of the new haiku based on the vector projection of the image feature and a vector project of any previously determined words for generation of the new haiku,

16. The method of claim 15, wherein the vector projection of the image feature is based on pixels in the image.

17. The method of claim 13, wherein each word in the words are extracted from the user haikus in the user haiku database based on the probability of the next word.

18. A system for a haiku chat bot, the system comprising:
at least one processor; and
a memory for storing and encoding computer executable instructions that, when executed by the at least one processor is operative to:
collect a haiku generation query from a user;
evaluate the haiku generation query to generate a new haiku, wherein words for the new haiku are extracted from user haikus in a user haiku database and combined to form the new haiku; and
provide the new haiku to the user in reply to the haiku generation query.

19. The system of claim 18, wherein the at least one processor is operative to:
collect user inputs;
generate the user haikus based on the user inputs; and
store the user haikus in the user haiku database.

20. The system of claim 18, wherein the haiku generation query is an image.
